(19) United States
(12) Patent Application Publication
(10) Pub. No.: US 2024/0365251 A1
(43) Pub. Date: Oct. 31, 2024

(54) METHOD AND APPARATUS FOR DETERMINING TRANSMIT POWER, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Wenhong CHEN, Dongguan (CN); Yun FANG, Dongguan (CN)

(21) Appl. No.: 18/767,145

(22) Filed: Jul. 9, 2024

Related U.S. Application Data
(63) Continuation of application No. PCT/CN2022/074419, filed on Jan. 27, 2022.

(51) Int. Cl. H04W 52/34; H04L 5/00

(52) U.S. Cl. CPC H04W 52/346; H04L 5/0053

(57) ABSTRACT

A method for determining a transmit power includes: receiving, by a terminal device, a first message, where the first message includes a plurality of indication information associated with different transmission layers of a physical uplink shared channel (PUSCH), transmission layers associated with different indication information correspond to different PTRS ports, and the indication information is sounding reference signal resource indicator (SRI) information or transmission configuration indicator (TCI) state information; determining, by the terminal device, a power boosting value of each PTRS port based on a number of target transmission layer(s), where the target transmission layers are any one of: transmission layer(s) associated with a respective one of the plurality of indication information, transmission layer(s) corresponding to the PTRS port, and all transmission layers of the PUSCH; and determining, by the terminal device, a transmit power of the PTRS port based on the power boosting value of the PTRS port.

### CROSS-REFERENCE TO RELATED APPLICATION

This application is a Continuation application of International Application No. PCT/CN2022/074419 filed Jan. 27, 2022, which is incorporated herein by reference in its entirety.

### TECHNICAL FIELD

The present disclosure relates to the field of mobile communication technology, and in particular, to a method and apparatus for determining a transmit power, a terminal device, and a network device.

### BACKGROUND

With the continuous evolution of antenna packaging technology, multiple antenna elements may be combined with a chip in a nested manner to form an antenna panel or an antenna array block (panel), which makes it possible to configure multiple low-correlation panels on a transmitter of a terminal device.

### SUMMARY

Embodiments of the present disclosure provide a method and apparatus for determining a transmit power, a terminal device, and a network device.

In a first aspect, a method for determining a transmit power is provided, which includes:
receiving, by a terminal device, a first message, where the first message includes a plurality of indication information associated with different transmission layers of a physical uplink shared channel (PUSCH), transmission layers associated with different indication information correspond to different PTRS ports, and the indication information is sounding reference signal resource indicator (SRI) information or transmission configuration indicator (TCI) state information;
determining, by the terminal device, a power boosting value of each PTRS port based on a number of target transmission layer(s), where the target transmission layer(s) are any one of: transmission layer(s) associated with a respective one of the plurality of indication information, transmission layer(s) corresponding to the PTRS port, and all transmission layers of the PUSCH; and
determining, by the terminal device, a transmit power of the PTRS port based on the power boosting value of the PTRS port.

In a second aspect, a method for determining a transmit power is provided, which includes:
transmitting, by a network device, a first message to a terminal device, where the first message includes a plurality of indication information associated with different transmission layers of a PUSCH, and transmission layers associated with different indication information correspond to different PTRS ports, and the indication information is SRI information or transmission configuration indicator (TCI) state information; a number of target transmission layer(s) is used to determine a power boosting value of each PTRS port, and the target transmission layer(s) are any one of: transmission layer(s) associated with a respective one of the plurality of indication information, transmission layer(s) corresponding to the PTRS port, and all transmission layers of the PUSCH.

In a third aspect, an apparatus for determining a transmit power is provided, which is applied to a terminal device and includes:
a receiving unit configured to receive a first message, where the first message includes a plurality of indication information associated with different transmission layers of a PUSCH, transmission layers associated with different indication information correspond to different PTRS ports, and the indication information is SRI information or TCI state information;
a first determining unit configured to determine a power boosting value of each PTRS port based on a number of target transmission layer(s), where the target transmission layer(s) are any one of: transmission layer(s) associated with a respective one of the plurality of indication information, transmission layer(s) corresponding to the PTRS port, and all transmission layers of the PUSCH; and
a second determining unit configured to determine a transmit power of the PTRS port based on the power boosting value of the PTRS port.

In a fourth aspect, the embodiments of the present disclosure provide an apparatus for determining a transmit power, which is applied to a network device and includes:
a transmitting unit configured to transmit a first message to a terminal device, where the first message includes a plurality of indication information associated with different transmission layers of a PUSCH, transmission layers associated with different indication information correspond to different PTRS ports, and the indication information is SRI information or TCI state information; a number of target transmission layer(s) is used to determine a power boosting value of each PTRS port, and the target transmission layer(s) are any one of: transmission layer(s) associated with a respective one of the plurality of indication information, transmission layer(s) corresponding to the PTRS port, and all transmission layers of the PUSCH.

In a fifth aspect, the embodiments of the present disclosure provide a terminal device including a processor and a memory. The memory is configured to store a computer program, and the processor is configured to call and run the computer program stored in the memory to cause the method for determining the transmit power in the foregoing first aspect to be performed.

In a sixth aspect, the embodiments of the present disclosure provide a network device including a processor and a memory. The memory is configured to store a computer program, and the processor is configured to call and run the computer program stored in the memory to cause the method for determining the transmit power in the foregoing second aspect to be performed.

In a seventh aspect, a chip provided in the embodiments of the present disclosure is configured to implement the above-mentioned method for determining the transmit power.

Specifically, the chip includes a processor configured to call and run a computer program from a memory to cause a device installed with the chip to perform the above-mentioned method for determining the transmit power.

In an eighth aspect, a computer-readable storage medium provided in the embodiments of the present disclosure is configured to store a computer program. The computer program causes a computer to perform the above-mentioned method for determining the transmit power.

In a ninth aspect, a computer program product provided in the embodiments of the present disclosure includes computer program instructions. The computer program instructions cause a computer to perform the above-mentioned method for determining the transmit power.

In a tenth aspect, a computer program provided in the embodiments of the present disclosure, when running on a computer, causes the computer to perform the above-mentioned method for determining the transmit power.

### BRIEF DESCRIPTION OF THE DRAWINGS

The drawings described herein are used to provide further understanding of the present disclosure and form a part of the present disclosure. The illustrative embodiments of the present disclosure and the descriptions thereof are used to explain the present disclosure and shall not be construed as improper limitations on the present disclosure. In the accompanying drawings:

FIG. 1 is a schematic diagram of a network architecture of an exemplary communication system provided by embodiments of the present disclosure;

FIG. 2A is a schematic diagram of an exemplary application scenario provided by embodiments of the present disclosure;

FIG. 2B is a schematic diagram of another exemplary application scenario provided by embodiments of the present disclosure;

FIG. 3 is a schematic flowchart of a method for determining a transmit power provided by embodiments of the present disclosure;

FIG. 4 is a first schematic diagram showing a structure of an apparatus for determining a transmit power provided by embodiments of the present disclosure;

FIG. 5 is a second schematic diagram showing a structure of an apparatus for determining a transmit power provided by embodiments of the present disclosure;

FIG. 6 is a schematic structural diagram of a communication device provided by embodiments of the present disclosure;

FIG. 7 is a schematic structural diagram of a chip according to embodiments of the present disclosure; and

FIG. 8 is a schematic block diagram of a communication system provided by embodiments of the present disclosure.

### DETAILED DESCRIPTION

Technical solutions in the embodiments of the present disclosure will be described below with reference to the accompanying drawings in the embodiments of the present disclosure. It is apparent that the embodiments described are some rather than all of the embodiments of the present disclosure. Based on the embodiments of the present disclosure, all other embodiments obtained by a person of ordinary skill in the art fall within the protection scope of the present disclosure.

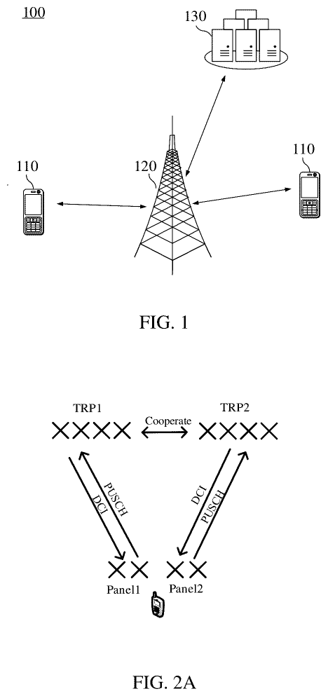

FIG. 1 is a schematic diagram of a network architecture of an exemplary communication system provided by embodiments of the present disclosure.

As shown in FIG. 1, a communication system 100 may include a terminal device 110 and a network device 120. The network device 120 may communicate with the terminal device 110 through an air interface. Multi-service transmission is supported between the terminal device 110 and the network device 120.

It should be understood that the communication system 100 is merely used as an example to describe the embodiments of the present disclosure, but the embodiments of the present disclosure are not limited thereto. That is, the technical solutions of the embodiments of the present disclosure may be applied to various communications systems, such as a long term evolution (LTE) system, an LTE time division duplex (TDD), a universal mobile telecommunication system (UMTS), an Internet of things (IoT) system, a narrow band Internet of things (NB-IoT) system, an enhanced machine-type communications (eMTC) system, a 5G communication system (also referred to as a new radio (NR) communication system), a future communication system, or the like.

In the communication system 100 shown in FIG. 1, the network device 120 may be an access network device that communicates with the terminal device 110. The access network device may provide communication coverage for a specific geographical area, and may communicate with the terminal device 110 (e.g., UE) located in the coverage area.

The network device 120 may be an evolutional base station (Evolutional Node B, eNB or eNodeB) in a long term evolution (LTE) system, a next generation radio access network (NG RAN) device, a base station (gNB) in a NR system, a wireless controller in a cloud radio access network (CRAN); or the network device may be a relay station, an access point, a vehicle-mounted device, a wearable device, a hub, a switch, a network bridge, a router, or a network device in a public land mobile network (PLMN) evolved in the future, etc.

The terminal device 110 may be any terminal device, including but not limited to a terminal device in a wired or wireless connection with the network device 120 or other terminal devices.

For example, the terminal device 110 may refer to an access terminal, a user equipment (UE), a subscriber unit, a subscriber station, a mobile station, a mobile console, a remote station, a remote terminal, a mobile device, a user terminal, a terminal, a wireless communication device, a user agent or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device having a wireless communication function, a computing device or other processing device connected to a wireless modem, a vehicle-mounted device, a wearable device, a terminal device in a 5G network, or a terminal device in a future evolution network, etc.

The terminal device 110 may be used for device to device (D2D) communication.

The wireless communications system 100 further includes a core network device 130 which communicates with a base station. The core network device 130 may be a 5G core (5GC) network device, such as an access and mobility management function (AMF), an authentication server function (AUSF), a user plane function (UPF), a session management function (SMF). Optionally, the core network device 130 may also be an evolved packet core (EPC) device in an LTE network, for example, a session management function+core packet gateway (SMF+PGW-C) device. It should be understood that SMF+PGW-C may implement both the functions that SMF can implement and the functions that PGW-C can implement. In the evolution process of the network, the core network device may also be called other names, or new network entities may be formed by dividing the functions of the core network, which is not limited in the embodiments of the present disclosure.

The various functional units in the communication system 100 may also communicate with each other by establishing connections via next generation (NG) network interfaces.

For example, the terminal device establishes an air interface connection with the access network device via an NR interface for transmission of user-plane data and control-plane signaling. The terminal device may establish a control-plane signaling connection to AMF via a NG interface 1 (N1 for short). The access network device, such as a next generation radio access base station (gNB), may establish a user-plane data connection to UPF via a NG interface 3 (N3 for short). The access network device may establish a control-plane signaling connection to AMF via a NG interface 2 (N2 for short). UPF may establish a control-plane signaling connection to SMF via a NG interface 4 (N4 for short). UPF may exchange user-plane data with a data network via a NG interface 6 (N6 for short). AMF may establish a control-plane signaling connection to SMF via a NG interface 11 (N11 for short). SMF may establish a control-plane signaling connection with PCF via a NG interface 7 (N7 for short).

FIG. 1 exemplarily illustrates one network device, one core network device and two terminal devices. Optionally, the wireless communication system 100 may include a plurality of network devices, each of which may have a coverage area in which other number of terminal devices are included, which is not limited in the embodiments of the present disclosure.

It should be noted that FIG. 1 merely exemplarily illustrates a system to which the present disclosure is applicable, and obviously the method in the embodiments of the disclosure may also be applied to other systems. Furthermore, terms “system” and “network” herein are often used interchangeably herein. The term “and/or” herein is only an association relationship to describe associated objects, which indicates that there may be three kinds of relationships. For example, A and/or B may indicate three cases where: A exists alone, both A and B exist, and B exists alone. In addition, a character “/” herein generally indicates that related objects before and after “/” are in an “or” relationship. It should be understood that “indication” involved in embodiments of the present disclosure may be a direct indication, may be an indirect indication, or may represent an association relationship. For example, A indicating B may mean that A indicates B directly, for example, B may be obtained through A; or may mean that A indicates B indirectly, for example, A indicates C, and B may be obtained through C; or may also mean that there is an association between A and B. It should also be understood that the term “correspond” involved in the embodiments of the present disclosure may mean that there is a direct or indirect correspondence between two elements, or may indicate an association between two elements, or may indicate a relationship of indicating and being indicated, configuring and being configured, etc. It should also be understood that the term “predefined” or “predefined rules” involved in the embodiments of the present disclosure may be achieved by pre-storing corresponding codes, tables or other manners that may be used to indicate relevant information in devices (e.g., including a terminal device and a network device). The specific implementation is not limited in the present disclosure. For example, “predefined” may refer to those defined in a protocol. It should also be understood that, in the embodiments of the present disclosure, “protocols” may refer to standard protocols in the field of communication, which may include, for example, a LTE protocol, an NR protocol and the relevant protocol applied in the future communication system, which is not limited in the present disclosure.

In order to facilitate understanding of the technical solutions of the embodiments of the present disclosure, related technologies involved in the embodiments of the present disclosure will be described below. The following relevant technologies, as optional solutions, can be arbitrarily combined with the technical solutions of the embodiments of the present disclosure, and these combined solutions all fall within the protection scope of the embodiments of the present disclosure.

In actual applications, each panel may independently form a transmission beam. In this way, a transmitter of a terminal device may send one or more data streams (a data stream may also be referred to as a transmission layer) over a plurality of panels simultaneously via different beams to improve the capacity or reliability of the transmission.

Since channel conditions corresponding to different panels are different, different panels need to use different transmission parameters according to their respective channel information. On this basis, the network device may configure different sounding reference signal (SRS) resources for different panels, so that the terminal device may obtain uplink channel information corresponding to each of the plurality of panels according to configured SRS resources. For example, the network device may configure a set of SRS resources for each panel of the terminal device, so that the terminal device may perform beam management on each panel separately according to the set of SRS resources corresponding to the panel, or determine transmission parameters such as the beams, the precoding vector and the number of transmission layers used by each panel to transmit the physical uplink shared channel (PUSCH).

In order to determine which panel to use for transmitting the signal, the network device may configure a plurality sets of reference signal resources for the terminal device and different sets of reference signal resources are transmitted or received using different panels, so as to indicate the panel used for transmitting the signal through a respective set of reference signal resources. For example, the sets of reference signal resources may be sets of channel state information reference signal (CSI-RS) resources or sets of SRS resources, which is not limited in the embodiments of the present disclosure.

In some embodiments, the network device may configure a plurality of reference signal indication information for the terminal device, and each reference signal indication information is associated with a respective set of reference signal resources. In this way, the terminal device may use the transmitting panel or receiving panel for the set of reference signals associated with the reference signal indication information as the transmitting panel for uplink signal. For example, the reference signal indication information may include SRS resource indicator (Sounding Resource Indicator, SRI) information, or transmission configuration indicator (TCI) state information, which is not limited in the embodiments of the present disclosure.

In some other embodiments, the network device may configure antenna panel identification information (i.e., a panel ID) for each uplink signal, and the terminal device determines the transmitting panel for the uplink signal according to the panel ID.

It can be understood that uplink signals transmitted over different panels may be called uplink signals associated with different sets of reference signal resources, or uplink signals associated with different panel IDs. Uplink signals associated with a same set of reference signal resources, or uplink signals associated with a same panel ID are transmitted using a same panel.

Uplink non-coherent transmission based on multiple transmission points (Transmission Reception Point, TRP) is introduced in NR systems. Different TRPs may independently schedule PUSCH transmissions of the same terminal device. Different PUSCH transmissions may be configured with independent transmission parameters, such as beams, precoding matrices, and the number of layers. The scheduled PUSCH transmissions may be transmitted in the same time slot or in different time slots. If a terminal is scheduled to transmit multiple PUSCHs simultaneously in the same time slot, the terminal needs to determine how to transmit the PUSCHs based on its own capabilities. If the terminal only has a single panel or does not support simultaneous transmission of multiple panels, the terminal may transmit PUSCHs over only one panel. If the terminal device is configured with multiple panels, the terminal device may transmit multiple PUSCHs at the same time, and the PUSCHs transmitted over different panels are aligned to respective TRPs for analog forming, thereby distinguishing different PUSCHs through the spatial domain and improving the spectrum efficiency in the uplink. For example, referring to FIGS. 2A and 2B, the terminal device is configured with two panels, i.e., panel 1 and panel 2. The terminal device may transmit a transmission layer of PUSCH through panel 1 and another transmission layer of PUSCH through panel 2.

Referring to FIG. 2A, PUSCHs transmitted to different TRPs may be scheduled based on a plurality of downlink control information (DCI), and the plurality of DCI may be carried by different sets of control resources (CORESETs). Specifically, the network device configures a plurality of CORESET groups, and each TRP uses CORESETs in its respective CORESET group to perform schedule, that is, different TRPs may be distinguished by the CORESET groups. For example, the network device may configure a CORESET group index for each CORESET, and different indexes correspond to different TRPs. As shown in FIG. 2B, PUSCHs transmitted to different TRPs may also be scheduled based on single DCI which needs to indicate parameters such as beams and DMRS ports used for transmitting PUSCHs to different TRPs. In this way, different transmission layers of PUSCH are transmitted over different panels by using independent transmission parameters (such as beams, precoding matrices, and power control parameters), but MCSs and physical resources used are the same. The beams used by PUSCH may be indicated by SRI information included in DCI or TCI state included in DCI.

In order to address the problem of phase noise in high bands, the 5th generation mobile communication technology (5G) has introduced a phase tracking reference signal (PTRS) to eliminate the impact of phase noise on a received signal. In actual applications, each panel may be associated with a PTRS port which is used to perform phase tracking of a signal on the panel.

Typically, the transmission of uplink signals is performed on a single panel, so the power boosting for different PTRS ports is the same. However, in a scenario where multiple panels are used to transmit uplink signals simultaneously, different panels may be associated with different PTRS ports, and power control is independent for different panels, so it is difficult for panels to borrow transmit power from each other. In this case, determining power boosting value of PTRS ports according to the prior art may result in different transmit powers of different OFDM symbols on a panel, thereby affecting the performance of uplink transmission. To avoid this situation, power boosting values need to be determined for the PTRS ports associated with different panels independently. How to determine the power boosting values of the PTRS ports associated with different panels in a scenario of simultaneous transmission of multiple panels is a problem that needs to be solved.

In order to support uplink transmission in high bands (e.g., FR2 band), a terminal device may be configured with 1 or 2 PTRS ports in which each PTRS port is associated with a different transmission layer, and PTRS may be used for phase tracking and adjustment of the associated transmission layers. For example, if the terminal device is configured with four transmission layers, PTRS port 0 is associated with transmission layers 0 and 1, and PTRS port 1 is associated with transmission layers 2 and 3. In addition, since a PTRS port may be associated with a plurality of transmission layers, in order to ensure that power on different orthogonal frequency division multiplexing (OFDM) symbols in the same uplink signal is the same, power of the PTRS port needs to be adjusted according to the number of configured transmission layers. Specifically, according to the number of transmission layers, a multiple-input multiple-output (MITVO) transmission mode of a PUSCH (including codebook based transmission or non-codebook based transmission), and a codebook coherent configuration (including full coherent configuration, partial coherent configuration and non-coherent configuration), the power boosting value of the PTRS port relative to the associated DMRS port may be obtained according to Table 1.

TABLE 1

| | | Total number of transmission layers of PUSCH | | | | | | |
|---|---|---|---|---|---|---|---|---|
| | | 2 | | 3 | | | | |
| | | | Partial | | Partial | | | |
| | | | coherent | | coherent | | | |
| | | | configur- | | configur- | | | |
| | | | ation | | ation | | | |
| | | | scenario, | | scenario, | 4 | | |
| | | | non- | | non- | | | Non- |
| | | | coherent | | coherent | | | coherent |
| | | | configur- | | configur- | | | configur- |
| | | | ation | | ation | | | ation |
| | | | scenario, | | scenario, | | | scenario |
| Mode | | | and | | and | | | and |
| to | | Full | non-code- | Full | non-code- | Full | Partial | non-code- |
| determine | | coherent | book based | coherent | book based | coherent | coherent | book based |
| power | 1 | configur- | trans- | configur- | trans- | configur- | configur- | trans- |
| boosting | All | ation | mission | ation | mission | ation | ation | mission |
| value | scenarios | scenario | scenario | scenario | scenario | scenario | scenario | scenario |
| 00 | 0 | 3 | 3Qₚ − 3 | 4.77 | 3Qₚ − 3 | 6 | 3Qₚ | 3Qₚ − 3 |
| 01 | 0 | 3 | 3 | 4.77 | 4.77 | 6 | 6 | 6 |

| | |
|---|---|
| 10 | Reserved |
| 11 | Reserved |

It should be noted that whether the terminal device adopts the power boosting mode indicated by “00” or the power boosting mode indicated by “01” may be configured by the network device. Qₚ is the number of PTRS ports currently configured (1 or 2).

Uplink signals are usually transmitted using a single panel, so the power boosting values of different PTRS ports are the same. However, in the scenario where multiple panels are used to transmit uplink information simultaneously, different panels may be associated with different PTRS ports, and the power control is independent for different panels, so it is difficult for panels to borrow transmit power from each other. In this case, if the power boosting value of the PTRS port is still determined using the mode shown in Table 1, the transmit powers of different OFDM symbols on a panel may be different, thereby affecting the performance of uplink transmission. To avoid this situation, power boosting values need to be determined independently for PTRS ports associated with different panels instead of using the same value for the PTRS ports. How to determine the power boosting values of the PTRS ports associated with different panels in a scenario of simultaneous transmission of multiple panels is a problem that needs to be solved.

Generally, a terminal device transmits uplink information through a single panel. However, at present, in a scenario where multiple panels are used to transmit uplink information simultaneously, there is no definitive solution on how to determine the transmit powers of multiple phase tracking reference signal (PTRS) ports.

In order to facilitate the understanding of technical solutions of the embodiments of the present disclosure, the technical solutions of the present disclosure will be described in detail below through specific embodiments. The related technologies described above, as optional solutions, can be arbitrarily combined with the technical solutions of the embodiments of the present disclosure, and these combined solutions all fall within the protection scope of the embodiments of the present disclosure. The embodiments of the present disclosure include at least part of the following content.

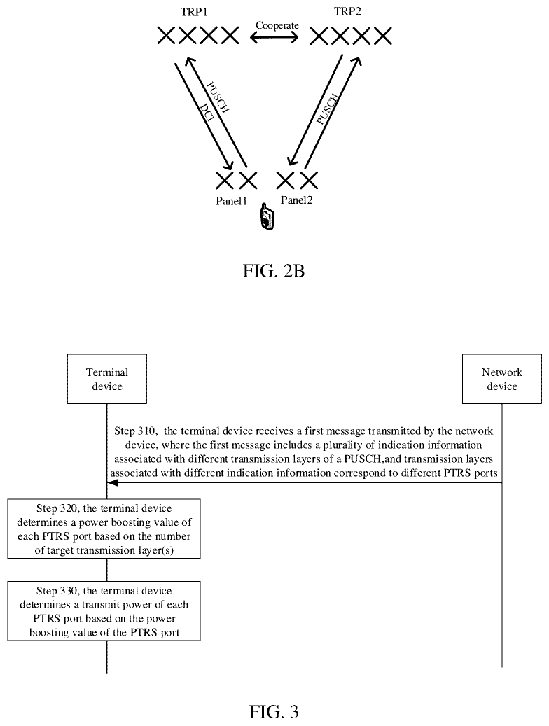

The embodiments of the present disclosure provide a method for determining a transmit power to solve the foregoing technical problem. Referring to FIG. 3, the method includes steps 310 to 330.

In step 310, a terminal device receives a first message transmitted by a network device. The first message includes a plurality of indication information associated with different transmission layers of a PUSCH. Transmission layers associated with different indication information correspond to different PTRS ports. The indication information may be SRI information or TCI state information.

Optionally, the first message may be downlink signaling for scheduling the PUSCH. The downlink signaling may be a higher layer signaling, such as an RRC signaling for scheduling a configured grant based PUSCH; the downlink signaling may also be physical layer signaling, such as downlink control information (DCI), which is not limited in the embodiments of the present disclosure.

Optionally, the PUSCH scheduled by the first message may include a plurality of transmission layers. The plurality of indication information is associated with different transmission layers of the PUSCH. It can be understood that one indication information may be associated with one or more transmission layers of the PUSCH, and different indication information is associated with different transmission layers.

It should be noted that an association relationship between the indication information and the transmission layers of the PUSCH may be configured by the network device or agreed upon between the terminal device and the network device, which is not limited in the embodiments of the present disclosure.

For example, the network device may agree in advance with the terminal device to determine the association relationship between the transmission layers of the PUSCH and the indication information based on the number of the transmission layers of the PUSCH and the number of indication information included in the first message. For example, if the number of indication information is 2 (including first indication information and second indication information), and the number of the transmission layers of the PUSCH is 4, the terminal device may determine that the first indication information is associated with transmission layer 0 and transmission layer 1 and the second indication information is associated with transmission layer 2 and transmission layer 3. When the number of the transmission layers of the PUSCH is 5 and the number of indication information is 2, the terminal device may determine that the first indication information is associated with transmission layer 0 and transmission layer 1, and the second indication information is associated with transmission layer 2, transmission layer 3 and transmission layer 4.

In addition, in the embodiments of the present disclosure, the network device may configure a plurality of PTRS ports for the terminal device.

Optionally, the network device may pre-configure the number of PTRS ports for the terminal device, and the PTRS ports may be PTRS ports corresponding to the number of PTRS ports configured by the network device. For example, if the number of PTRS ports is 2, the PTRS ports are PTRS ports 0 and 1; alternatively, if the number of PTRS ports is 4, the PTRS ports are PTRS ports 0 to 3.

In the embodiments of the present disclosure, the plurality of transmission layers of the PUSCH may correspond to the plurality of PTRS ports, and different PTRS ports correspond to different transmission layers. For example, transmission layer 0 and transmission layer 1 correspond to PTRS port 0, and transmission layer 2 and transmission layer 3 correspond to PTRS port 1.

It should be noted that the correspondence between the plurality of transmission layers of the PUSCH and the PTRS ports may be configured by the network device or agreed upon between the network device and the terminal device, which is not limited in the embodiments of the present disclosure.

In the embodiments of the present disclosure, that PTRS ports corresponding to transmission layers associated with different indication information are different may refer to that one or more transmission layers associated with one indication information may correspond to one PTRS port and the PTRS port corresponding to one or more transmission layers associated with one indication information is different from the PRS port corresponding to one or more transmission layers associated with another indication information.

It should be noted that the indication information in the embodiments of the present disclosure may be SRI information or TCI state information. In practical applications, the SRI information or the TCI state information may be used to indicate a reference signal resource in a set of reference signal resources that is provided to the terminal device to determine a panel used for transmitting signals. That is, different SRI information or TCI state information may be used to indicate transmissions on different panels.

It can be understood that the first message is specifically used to instruct to transmit the PUSCH on a plurality of panels of the terminal device simultaneously, and the plurality of indication information and the plurality of panels are in a one-to-one correspondence.

Optionally, before step 310, the terminal device may report to the network device the number of panels it includes and whether the terminal device supports simultaneous transmission of the PUSCH over the panels. In this way, in the case where the terminal device reports that it includes a plurality of panels and supports simultaneous transmission over the plurality of panels, the network device may transmit the first message to the terminal device based on the information reported by the terminal device, so as to instruct the terminal device through the first message to transmit the PUSCH scheduled by the first message over some or all of the plurality of panels.

In the embodiments of the present disclosure, since the SRI information or the TCI state information may be associated with panels, according to an association relationship between the indication information (i.e., the SRI information or the TCI state information) and the transmission layers of the PUSCH and a correspondence between transmission layers and PTRS ports, the terminal device may obtain the allocation of transmission layers of the PUSCH on different panels (indicated by different SRI information or TCI state information).

In step 320, the terminal device determines a power boosting value of each PTRS port based on the number of target transmission layer(s).

The target transmission layer(s) may include any one of: transmission layer(s) associated with a respective one of the plurality of indication information, transmission layer(s) corresponding to the PTRS port, and all transmission layers of the PUSCH.

It should be understood that one or more transmission layers associated with one indication information may correspond to one PTRS port. That is, the indication information and the PTRS ports are in a one-to-one correspondence.

On this basis, in a possible implementation, the terminal device may determine, according to the number of transmission layer(s) associated with a respective one of the plurality of indication information, a power boosting value of the PTRS port corresponding to the indication information.

Optionally, the number of transmission layer(s) associated with each of the plurality of indication information may be determined according to the number of transmission layers of the PUSCH and the number of the plurality of indication information. For example, if the number of transmission layers of the PUSCH is 4 and the number of the indication information is 2, the number of transmission layers associated with each indication information is 2. If the number of transmission layers of the PUSCH is 5 and the number of indication information is 2, the number of transmission layers associated with one indication information is 2, and the number of transmission layers associated with the other indication information is 3.

Optionally, the number of transmission layers of the PUSCH may be configured by the network device. Before step 320, the network device may further transmit third configuration information to the terminal device, so as to indicate the number of transmission layers of the PUSCH to the terminal device through the third configuration information. Here, the third configuration information may be carried by the first message, or by other information other than the first message, which is not limited in the embodiments of the present disclosure.

In another possible implementation, the terminal device may also directly determine the power boosting value of each PTRS port according to the number of transmission layer(s) corresponding to the PTRS port.

In yet another possible implementation, in the case where the transmission layers of the PUSCH on different panels are the same, that is, the number of transmission layers associated with different indication information of the plurality of indication information is the same, or the number of transmission layers associated with different PTRS ports is the same, the terminal device may determine the power boosting value of each PTRS port based on the total number of transmission layers of the PUSCH.

It should be noted that the power boosting value may be a power boosting value of a target PTRS port relative to a demodulation reference signal (DMRS) port associated with the target PTRS port. The target PTRS port is any one of the plurality of PTRS ports. For example, a power boosting value of 3 dB may indicate that the transmit power of the PTRS port is 3 dB higher than the power of its associated DMRS port.

That is to say, the terminal device may determine power boosting values used by PTRS ports corresponding to different panels according to the allocation of transmission layers of the PUSCH on the plurality of panels (different panels may be represented by different indication information).

In step 330, the terminal device determines a transmit power of the PTRS port based on the power boosting value of the PTRS port.

It can be understood that the terminal device may determine a transmit power on each PTRS port based on a transmit power of a DMRS port associated with the PTRS port and the power boosting value of the PTRS port, thereby obtaining a transmit power corresponding to each PTRS port.

To summarize, in the method for determining a transmit power provided in the embodiments of the present disclosure, since the SRI information or the TCI state information may be associated with panels, the terminal device in the embodiments of the present disclosure may obtain the allocation of the transmission layers of the PUSCH on different panels (through different SRI information or TCI state information), according to an association relationship between the indication information (i.e., SRI information or TCI state information) in the first message and the transmission layers of the PUSCH and a correspondence between transmission layers and PTRS ports, thereby determining power boosting values used by PTRS ports corresponding to different panels. In this way, in a scenario where multiple panels transmit uplink information simultaneously, the terminal device may accurately determine the transmit power of each PRTS port, ensuring not only normal data transmission but also the power balance between different OFDM symbols and different panels, and reducing the complexity of hardware implementation of the terminal device.

In the embodiment of the present disclosure, in step 320, the terminal device may determine the power boosting value of each PTRS port based on the number of the target transmission layer(s) in various ways, two of which are described below.

Manner 1: the terminal device may determine the power boosting value of each PTRS port based on the number of the target transmission layer(s), a MIMO transmission mode of the PUSCH and a codebook coherent configuration.

Optionally, the MIMO transmission mode of the PUSCH may include codebook based transmission or non-codebook based transmission. The codebook coherent configuration may include full coherent configuration, partial coherent configuration, or non-coherent configuration. The MIMO transmission mode of the PUSCH and the codebook coherent configuration may be notified to the terminal device in advance through higher layer signaling.

It can be understood that the terminal device may determine the power boosting value of each PTRS port based on a different number of target transmission layer(s), a different MIMO transmission mode, and a different codebook coherent configuration.

Optionally, the terminal device may determine the power boosting value of each PTRS port according to a preset mapping relationship between the number of target transmission layers, MIMO transmission modes, codebook coherent configurations and the power boosting values.

It should be noted that the mapping relationship between the number of target transmission layers, MIMO transmission modes, codebook coherent configurations and the power boosting values may be pre-configured by the network device for the terminal device, or may be agreed upon between the network device and the terminal device, which is not limited in the embodiments of the present disclosure.

Manner 2: the terminal device may directly determine the power boosting value of each PTRS port based on the number of the target transmission layer(s).

That is to say, the terminal device may determine the power boosting value of each PTRS port based on the number of the target transmission layer(s). The power boosting value determined according to manner 2 is not related to the MIMO transmission mode and the codebook coherent configuration.

Optionally, the terminal device may determine the power boosting value of each PTRS port according to a preset mapping relationship between the number of target transmission layers and power boosting values.

It should be noted that the mapping relationship between the number of target transmission layers and power boosting values may be pre-configured by the network device for the terminal device, or may be agreed upon between the network device and the terminal device, which is not limited in the embodiments of the present disclosure.

In the embodiments of the present disclosure, it is configured by the network device whether the above-mentioned manner 1 or manner 2 is used by the terminal device to determine the power boosting value of each PTRS port.

Optionally, before step 320, the terminal device may receive second configuration information transmitted by the network device. The second configuration information is used to configure one of the following two manners: the terminal device determines the power boosting value of each PTRS port based on the number of target transmission layer(s); or the terminal device determines the power boosting value of each PTRS port based on the number of target transmission layer(s), the MIMO transmission mode and the codebook coherent configuration mode.

In some embodiments, the second configuration information may be carried via higher layer signaling. The signaling for carrying the second configuration information is not limited in the embodiments of the present disclosure.

Optionally, the network device may send second configuration information to the terminal device based on capability information reported by the terminal device so as to instruct the terminal device to use the above-mentioned manner 1 or manner 2 to determine the power boosting value of each PTRS port.

Optionally, before the network device transmits the second configuration information, the network device may receive the capability information transmitted by the terminal device. The capability information may be used to indicate at least one of:
whether the terminal device supports enhanced PTRS power boosting;
whether transmission layers associated with different indication information support sharing of a transmit power; or
whether antenna panels of the terminal device support sharing of a transmit power.

In some embodiments, if the capability information indicates that the terminal device supports enhanced PTRS power boosting, or indicates that the transmission layers associated with the different indication information support sharing of a transmit power, or indicates that the multiple antenna panels of the terminal device support sharing of a transmit power, the network device instructs the terminal device via the second configuration information to determine the power boosting value of each PTRS port based on the number of the target transmission layer(s), the MIMO transmission mode and the codebook coherent configuration mode. That is, the network device may instruct the terminal device via the second configuration information to determine the power boosting value of each PTRS port by using the above-mentioned manner 1, so as to obtain the higher PTRS transmit power.

In some other embodiments, if the capability information indicates that the terminal device does not support enhanced PTRS power boosting, or indicates that the transmission layers associated with the different indication information do not support sharing of a transmit power, or indicates that the multiple antenna panels of the terminal device do not support sharing of a transmit power, the network device instructs the terminal device via the second configuration information to determine the power boosting value of each PTRS port based on the number of the target transmission layer(s). That is, the network device may instruct the terminal device to determine the power boosting value of each PTRS port by using the above-mentioned manner 2, so as to reduce the implementation complexity of the terminal device.

In the embodiments of the present disclosure, the target transmission layer(s) may be any one of: transmission layer(s) associated with a respective one of the plurality of indication information, transmission layer(s) corresponding to the PTRS port, and all transmission layers of the PUSCH. The following will describe in detail how the terminal device obtains the power boosting value of each PTRS port when the target transmission layer(s) are in the three different situations mentioned above.

Embodiment 1: the target transmission layer(s) are transmission layer(s) associated with a respective one of the plurality of indication information.

Optionally, the plurality of indication information in this embodiment may include first indication information and second indication information, where the first indication information is associated with first transmission layer(s) of the PUSCH, and the second indication information is associated with second transmission layer(s) of the PUSCH. Furthermore, the number of PTRS ports configured by the network device for the terminal device is 2. The first transmission layer(s) correspond to a first PTRS port, and the second transmission layer(s) correspond to a second PTRS port.

In a possible implementation, in the case where the target transmission layer(s) are transmission layer(s) associated with a respective one of the plurality of indication information, the terminal device may determine the power boosting value of each PTRS port according to the mapping relationship shown in Table 2-1.

Optionally, in the case where the terminal device is in a first scenario, the terminal device may determine the power boosting value of each PTRS port according to the mapping relationship shown in Table 2-1. The first scenario may be that resources occupied by a target PTRS port are available for transmission of transmission layer(s) other than transmission layer(s) corresponding to the target PTRS port in plurality of transmission layers. The target PTRS port herein is any one of the plurality of PTRS ports.

That is to say, in the case where the resources occupied by any PTRS port are available for transmission of transmission layer(s) other than the transmission layer(s) corresponding to the PTRS port, the terminal device may determine the power boosting value of each PTRS port based on the mapping relationship shown in Table 2-1.

In the embodiments of the present disclosure, that the resources occupied by any PTRS port are available for transmission of transmission layer(s) other than the transmission layer(s) corresponding to the PTRS port may refer to that: physical resources occupied by the first PTRS port are available for transmission of data of the second transmission layer(s) of the PUSCH, and are unavailable for transmission of data of the first transmission layer(s) corresponding to the first PTRS port; and physical resources occupied by the second PTRS port are available for transmission of data of the first transmission layer(s) of the PUSCH, and are unavailable for transmission of data of the second transmission layer(s) corresponding to the second PTRS port. Since the first transmission layer(s) and the first PTRS port are transmitted on the same panel (represented by the first indication information), and the second transmission layer(s) and the second PTRS port are transmitted on another panel (represented by the second indication information), the above first scenario may be understood as that the data on one panel does not need a rate matching operation with the PTRS on another panel.

In the first scenario, in order to ensure that signal transmit powers on different OFDMs are the same, power boost may be performed for the PTRS port on each panel based on the number of transmission layer(s) on the panel, without considering signal transmission on another panel. On this basis, the terminal device may use the mapping relationship shown in the following Table 2-1 to determine the power boosting values of the first PTRS port and the second PTRS port.

TABLE 2-1

| Trans- | | | | | | | | | |
|---|---|---|---|---|---|---|---|---|---|
| mission | | | | | | | | | |
| mode and | {M, N} | | | | | | | | |
| coherent | {1, 1} | {1, 2} | | {2, 2} | | {2, 3} | | {3, 3} | |
| configur- | Configur- | Configur- | Configur- | Configur- | Configur- | Configur- | Configur- | Configur- | Configur- |
| ation | ation 1-4 | ation 1 | ation 2-4 | ation 1 | ation 2-4 | ation 1 | ation 2-4 | ation 1 | ation 2-4 |
| Power | {0, 0} | {0, 3} | {0, 0} | {3, 3} | {0, 0} | {3, 4.77} | {0, 0} | {4.77, 4.77} | {0, 0} |
| boosting | | | | | | | | | |
| configur- | | | | | | | | | |
| ation 1 | | | | | | | | | |
| Power | {0, 0} | {0, 3} | {0, 3} | {3, 3} | {3, 3} | {3, 4.77} | {3, 4.77} | {4.77, 4.77} | {4.77, 4.77} |
| boosting | | | | | | | | | |
| configur- | | | | | | | | | |
| ation 2 | | | | | | | | | |

| Trans- | | | | | | |
|---|---|---|---|---|---|---|
| mission | | | | | | |
| mode and | {M, N} | | | | | |
| coherent | {3, 4} | | | {4, 4} | | |
| configur- | Configur- | Configur- | Configur- | Configur- | Configur- | Configur- |
| ation | ation 1 | ation 2 | ation 3-4 | ation 1 | ation 2 | ation 3-4 |
| Power | {4.77, 6} | {0, 3} | {0, 0} | {6, 6} | {3, 3} | {0, 0} |
| boosting | | | | | | |
| configur- | | | | | | |
| ation 1 | | | | | | |
| Power | {4.77, 6} | {4.77, 6} | {4.77, 6} | {6, 6} | {6, 6} | {6, 6} |
| boosting | | | | | | |
| configur- | | | | | | |
| ation 2 | | | | | | |

M is the number of first transmission layer(s) associated with the first indication information, and N is the number of second transmission layer(s) associated with the second indication information. In the case where the maximum number of transmission layers supported by the terminal device is 8 (at most 4 transmission layers are supported on each panel), the following 7 cases may be included for the number of transmission layers {M,N} associated with the first indication information and the second indication information: {1,1}, {1,2}, {2,2}, {2,3}, {3,3}, {3,4}, and {4,4}.

In addition, four types of configuration may be included for the transmission mode and the coherent configuration: configuration 1 to configuration 4. The configuration 1 refers to that the MIMO transmission mode of the PUSCH is codebook based transmission and the codebook coherent configuration is full coherent configuration. The configuration 2 refers to that the MIMO transmission mode of the PUSCH is codebook based transmission and the codebook coherent configuration is partial coherent configuration. The configuration 3 refers to that the MIMO transmission mode of the PUSCH is codebook based transmission and the codebook coherent configuration is non-coherent configuration. The configuration 4 refers to that the MIMO transmission mode of the PUSCH is non-codebook based transmission.

Optionally, in the first scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a first mapping relationship (i.e., the mapping relationship indicated by the power boosting configuration 1 shown in Table 2-1).

As can be seen from Table 2-1 that the first mapping relationship may specifically include at least one of the following cases. In the case where M=1 and N=1, both the first PTRS port and the second PTRS port have a power boosting value of 0 dB. In the case where M=1 and N=2: if the transmission mode and coherent configuration of the terminal device is the configuration 1 (that is, the MIMO transmission mode is codebook based transmission and the codebook coherent configuration is full coherent configuration), the first PTRS port has a power boosting value of 0 dB, and the second PTRS port has a power boosting value of 3 dB; if the transmission mode and coherent configuration of the terminal device is any one of the configuration 2 to the configuration 4 (that is, the MIMO transmission mode is non-codebook based transmission, or the MIMO transmission mode is codebook based transmission and the codebook coherent configuration is non-full coherent configuration), both the first PTRS port and the second PTRS port have a power boosting value of 0 dB.

By analogy, in the case where M=4 and N=4: if the transmission mode and coherent configuration of the terminal device is the configuration 1, both the first PTRS port and the second PTRS port have a power boosting value of 6 dB; if the transmission mode and coherent configuration of the terminal device is the configuration 2, both the first PTRS port and the second PTRS port have a power boosting value of 3 dB; if the transmission mode and coherent configuration of the terminal device is the configuration 3 or the configuration 4, both the first PTRS port and the second PTRS port have a power boosting value of 0 dB.

Optionally, in the first scenario, if the second configuration information transmitted by the network device instructs the terminal device to use manner 2 (i.e., determining the power boosting value of each PTRS port based on the number of the target transmission layer(s)) to determine the power boosting value, the terminal device may determine the power boosting value of each PTRS port based on a third mapping relationship (i.e., the mapping relationship indicated by the power boosting configuration 2 shown in Table 2-1).

As can be seen from Table 2-1 that the third mapping relationship may include: in the case where M=1 and N=1, both the first PTRS port and the second PTRS port having a power boosting value of 0 dB; in the case where M=1 and N=2, the first PTRS port having a power boosting value of 0 dB, and the second PTRS port having a power boosting value of 3 dB; in the case where M=2 and N=2, both the first PTRS port and the second PTRS port having a power boosting value of 3 dB; in the case where M=2 and N=3, the first PTRS port having a power boosting value of 3 dB, and the second PTRS port having a power boosting value of 4.77 dB; in the case where M=3 and N=3, both the first PTRS port and the second PTRS port having a power boosting value of 4.77 dB; in the case where M=3 and N=4, the first PTRS port having a power boosting value of 4.77 dB, and the second PTRS port having a power boosting value of 6 dB; in the case where M=4 and N=4, both the first PTRS port and the second PTRS port having a power boosting value of 6 dB. In these cases, the magnitude of the power boosting value is not related to the MIMO transmission mode and the codebook coherent configuration.

It should be noted that, in the embodiments of the present disclosure, presenting the above-mentioned mapping relationships in the manner of Table 2-1 is only for the sake of simplicity of description, rather than to limit that power boosting values corresponding to different numbers of transmission layers, different transmission modes and different coherent configurations are all determined according to the mapping relationships shown in Table 2-1. That is to say, the mapping relationship indicated by the power boosting configuration 1 and the mapping relationship indicated by the power boosting configuration 2 shown in the above Table 2-1 may be applied separately. In addition, the power boosting values corresponding to different numbers of transmission layers, different transmission modes and different coherent configurations indicated by the power boosting configuration 1 in Table 2-1 may be applied separately, and the power boosting values corresponding to different numbers of transmission layers, different transmission modes and different coherent configurations indicated by the power boosting configuration 2 in Table 2-1 may also be applied separately. For example, the terminal device may determine a power boosting value of a PTRS port when the values of {M,N} are {1,1} only based on Table 2-1, and determine power boosting values of the PTRS port corresponding to other values of {M,N} in a manner different from Table 2-1.

Optionally, if each panel may only support at most two transmission layers, that is, M and N are not greater than 2, Table 2-2 may be used to determine a power boosting value of a PTRS port corresponding to each panel.

TABLE 2-2

| | {M, N} | | | | |
|---|---|---|---|---|---|
| | {1, 1} | {1, 2} | | {2, 2} | |
| Transmission mode | Config- | Config- | Config- | Config- | Config- |
| and coherent | uration | uration | uration | uration | uration |
| configuration | 1-4 | 1 | 2-4 | 1 | 2-4 |
| Power boosting | {0, 0} | {0, 3} | {0, 0} | {3, 3} | {0, 0} |
| configuration 1 | | | | | |
| Power boosting | {0, 0} | {0, 3} | {0, 3} | {3, 3} | {3, 3} |
| configuration 2 | | | | | |

It should be noted that Table 2-2 may be part of the content of Table 2-1. It should be noted that the mapping relationship indicated by the power boosting configuration 1 and the mapping relationship indicated by the power boosting configuration 2 shown in the above Table 2-2 may be applied separately. In addition, the power boosting values corresponding to different numbers of transmission layers, different transmission modes and different coherent configurations indicated by the power boosting configuration 1 in Table 2-2 may be applied separately, and the power boosting values corresponding to different numbers of transmission layers, different transmission modes and different coherent configurations indicated by the power boosting configuration 2 in Table 2-2 may also be applied separately.

In addition, in the case where the target transmission layer(s) are the transmission layer(s) associated with a respective one of the plurality of indication information, the terminal device may also determine the power boosting value of each PTRS port according to the mapping relationship shown in Table 3-1.

Optionally, in the case where the terminal device is in the second scenario, the terminal device may determine the power boosting value of each PTRS port according to the mapping relationship shown in Table 3-1. The second scenario may be that resources occupied by the plurality of PTRS ports are unavailable for transmission of the PUSCH, that is, the data on one panel of the terminal device needs to be rate-matched with the PTRS signal on another panel.

On this basis, in the second scenario, in order to ensure that signal transmit powers on different OFDMs are the same, in an aspect, it is necessary to perform power boost for a PTRS port on each panel according to the number of transmission layers on the panel; in another aspect, it is also necessary to consider the additional power required due to rate matching on PTRS resources of another panel, that is, it is necessary to add an additional 3 dB on the basis of Table 2-1, resulting in Table 3-1 as shown below. The terminal device may determine the power boosting values of the first PTRS port and the second PTRS port using the mapping relationship shown in the following Table 3-1.

TABLE 3-1

| Trans- | | | | | | | | | |
|---|---|---|---|---|---|---|---|---|---|
| mission | | | | | | | | | |
| mode and | {M, N} | | | | | | | | |
| coherent | {1, 1} | {1, 2} | | {2, 2} | | {2, 3} | | {3, 3} | |
| configur- | Configur- | Configur- | Configur- | Configur- | Configur- | Configur- | Configur- | Configur- | Configur- |
| ation | ation 1-4 | ation 1 | ation 2-4 | ation 1 | ation 2-4 | ation 1 | ation 2-4 | ation 1 | ation 2-4 |
| Power | {3, 3} | {3, 6} | {3, 3} | {6, 6} | {3, 3} | {6, 7.77} | {3, 3} | {7.77, 7.77} | {3, 3} |
| boosting | | | | | | | | | |
| configur- | | | | | | | | | |
| ation 1 | | | | | | | | | |
| Power | {3, 3} | {3, 6} | {3, 6} | {6, 6} | {6, 6} | {6, 7.77} | {6, 7.77} | {7.77, 7.77} | {7.77, 7.77} |
| boosting | | | | | | | | | |
| configur- | | | | | | | | | |
| ation 2 | | | | | | | | | |

| Trans- | | | | | | |
|---|---|---|---|---|---|---|
| mission | | | | | | |
| mode and | {M, N} | | | | | |
| coherent | {3, 4} | | | {4, 4} | | |
| configur- | Configur- | Configur- | Configur- | Configur- | Configur- | Configur- |
| ation | ation 1 | ation 2 | ation 3-4 | ation 1 | ation 2 | ation 3-4 |
| Power | {7.77, 9} | {3, 6} | {3, 3} | {9, 9} | {6, 6} | {3, 3} |
| boosting | | | | | | |
| configur- | | | | | | |
| ation 1 | | | | | | |
| Power | {7.77, 9} | {7.77, 9} | {7.77, 9} | {9, 9} | {9, 9} | {9, 9} |
| boosting | | | | | | |
| configur- | | | | | | |
| ation 2 | | | | | | |

Optionally, in the second scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a second mapping relationship (i.e., the mapping relationship indicated by the power boosting configuration 1 shown in Table 3-1).

As can be seen from Table 3-1 that the second mapping relationship may specifically include at least one of the following: in the case where M=1 and N=1, both the first PTRS port and the second PTRS port have a power boosting value of 3 dB;
in the case where M=1 and N=2: if the transmission mode and coherent configuration of the terminal device is the configuration 1, the first PTRS port has a power boosting value of 3 dB, and the second PTRS port has a power boosting value of 6 dB; if the transmission mode and coherent configuration of the terminal device is any one of the configuration 2 to the configuration 4, both the first PTRS port and the second PTRS port have a power boosting value of 3 dB.

By analogy, in the case where M=4 and N=4: if the transmission mode and coherent configuration of the terminal device is the configuration 1, both the first PTRS port and the second PTRS port have a power boosting value of 9 dB; if the transmission mode and coherent configuration of the terminal device is the configuration 2, both the first PTRS port and the second PTRS port have a power boosting value of 6 dB; if the transmission mode and coherent configuration of the terminal device is the configuration 3 or the configuration 4, both the first PTRS port and the second PTRS port have a power boosting value of 3 dB.

Optionally, in the second scenario, if the second configuration information transmitted by the network device instructs the terminal device to use manner 2 (i.e., determining the power boosting value of each PTRS port based on the number of the target transmission layer(s)) to determine the power boosting value, the terminal device may determine the power boosting value of each PTRS port based on a fourth mapping relationship (i.e., the mapping relationship indicated by the power boosting configuration 2 shown in Table 3-1).

It can be seen from Table 3-1 that the fourth mapping relationship may specifically include: in the case where M=1 and N=1, both the first PTRS port and the second PTRS port having a power boosting value of 3 dB; in the case where M=1 and N=2, the first PTRS port having a power boosting value of 3 dB, and the second PTRS port having a power boosting value of 6 dB; in the case where M=2 and N=2, both the first PTRS port and the second PTRS port having a power boosting value of 6 dB; in the case where M=2 and N=3, the first PTRS port having a power boosting value of 6 dB, and the second PTRS port having a power boosting value of 7.77 dB; in the case where M=3 and N=3, both the first PTRS port and the second PTRS port having a power boosting value of 7.77 dB; in the case where M=3 and N=4, the first PTRS port having a power boosting value of 7.77 dB, and the second PTRS port having a power boosting value of 9 dB; in the case where M=4 and N=4, both the first PTRS port and the second PTRS port having a power boosting value of 9 dB. In these cases, the magnitude of the power boosting value is not related to the MIMO transmission mode and the codebook coherent configuration.

It should be noted that, in the embodiments of the present disclosure, presenting the above-mentioned mapping relationships in the manner of Table 3-1 is only for the sake of simplicity of description, rather than to limit that power boosting values corresponding to different numbers of transmission layers, different transmission modes and different coherent configurations are all determined according to the mapping relationships shown in Table 3-1. That is to say, the mapping relationship indicated by the power boosting configuration 1 and the mapping relationship indicated by the power boosting configuration 2 shown in the above Table 3-1 may be applied separately. In addition, the power boosting values corresponding to different numbers of transmission layers, different transmission modes and different coherent configurations indicated by the power boosting configuration 1 in Table 3-1 may be applied separately, and the power boosting values corresponding to different numbers of transmission layers, different transmission modes and different coherent configurations indicated by the power boosting configuration 2 in Table 3-1 may also be applied separately. For example, the terminal device may determine a power boosting value of a PTRS port when the values of {M,N} are {1,1} only based on Table 3-1, and determine power boosting values of the PTRS port corresponding to other values of {M,N} in a manner different from Table 3-1.

Optionally, if each panel may only support at most two transmission layers, that is, M and N are not greater than 2, Table 3-2 may be used to determine power boosting values.

TABLE 3-2

| | {M, N} | | | | |
|---|---|---|---|---|---|
| | {1, 1} | {1, 2} | | {2, 2} | |
| Transmission mode | Config- | Config- | Config- | Config- | Config- |
| and coherent | uration | uration | uration | uration | uration |
| configuration | 1-4 | 1 | 2-4 | 1 | 2-4 |
| Power boosting | {3, 3} | {3, 6} | {3, 3} | {6, 6} | {3, 3} |
| configuration 1 | | | | | |
| Power boosting | {3, 3} | {3, 6} | {3, 6} | {6, 6} | {6, 6} |
| configuration 2 | | | | | |

Table 3-2 may be part of the content of Table 3-1. It should be noted that the mapping relationship indicated by the power boosting configuration 1 and the mapping relationship indicated by the power boosting configuration 2 shown in the above Table 3-2 may be applied separately. In addition, the power boosting values corresponding to different numbers of transmission layers, different transmission modes and different coherent configurations indicated by the power boosting configuration 1 in Table 3-2 may be applied separately, and the power boosting values corresponding to different numbers of transmission layers, different transmission modes and different coherent configurations indicated by the power boosting configuration 2 in Table 3-2 may also be applied separately.

In another possible implementation, if the terminal device only supports performing PUSCH transmission on multiple panels by using a MIMO transmission mode of codebook based transmission, the terminal device may use a mapping relationship shown in Table 4-1 or Table 5-1 to determine the power boosting value of each PTRS port based on a value of the number M of first transmission layer(s) associated with the first indication information, a value of the number N of second transmission layer(s) associated with the second indication information, and the codebook coherent configuration. In this implementation, there may also be two scenarios for determining the power boosting value of each PTRS port.

Optionally, in the first scenario, that is, in the case where resources occupied by a target PTRS port are available for transmission of transmission layer(s) other than transmission layer(s) corresponding to the target PTRS port, the terminal device may determine power boosting values of the first PTRS port and the second PTRS port according to a mapping relationship shown in Table 4-1 below.

TABLE 4-1

| Trans- | | | | | | | | | |
|---|---|---|---|---|---|---|---|---|---|
| mission | | | | | | | | | |
| mode and | {M, N} | | | | | | | | |
| coherent | {1, 1} | {1, 2} | | {2, 2} | | {2, 3} | | {3, 3} | |
| configur- | Configur- | Configur- | Configur- | Configur- | Configur- | Configur- | Configur- | Configur- | Configur- |
| ation | ation 1-3 | ation 1 | ation 2-3 | ation 1 | ation 2-3 | ation 1 | ation 2-3 | ation 1 | ation 2-3 |
| Power | {0, 0} | {0, 3} | {0, 0} | {3, 3} | {0, 0} | {3, 4.77} | {0, 0} | {4.77, 4.77} | {0, 0} |
| boosting | | | | | | | | | |
| configur | | | | | | | | | |
| ation 1 | | | | | | | | | |
| Power | {0, 0} | {0, 3} | {0, 3} | {3, 3} | {3, 3} | {3, 4.77} | {3, 4.77} | {4.77, 4.77} | {4.77, 4.77} |
| boosting | | | | | | | | | |
| configur | | | | | | | | | |
| ation 2 | | | | | | | | | |

| Trans- | | | | | | |
|---|---|---|---|---|---|---|
| mission | | | | | | |
| mode and | {M, N} | | | | | |
| coherent | {3, 4} | | | {4, 4} | | |
| configur- | Configur- | Configur- | Configur- | Configur- | Configur- | Configur- |
| ation | ation 1 | ation 2 | ation 3 | ation 1 | ation 2 | ation 3 |
| Power | {4.77, 6} | {0, 3} | {0, 0} | {6, 6} | {3, 3} | {0, 0} |
| boosting | | | | | | |
| configur | | | | | | |
| ation 1 | | | | | | |
| Power | {4.77, 6} | {4.77, 6} | {4.77, 6} | {6, 6} | {6, 6} | {6, 6} |
| boosting | | | | | | |
| configur | | | | | | |
| ation 2 | | | | | | |

It should be noted that, in the embodiments of the present disclosure, presenting the above-mentioned mapping relationships in the manner of Table 4-1 is only for the sake of simplicity of description, rather than to limit that power boosting values corresponding to different numbers of transmission layers, different transmission modes and different coherent configurations are all determined according to the mapping relationships shown in Table 4-1. That is to say, the mapping relationship indicated by the power boosting configuration 1 and the mapping relationship indicated by the power boosting configuration 2 shown in the above Table 4-1 may be applied separately. In addition, the power boosting values corresponding to different numbers of transmission layers, different transmission modes and different coherent configurations indicated by the power boosting configuration 1 in Table 4-1 may be applied separately, and the power boosting values corresponding to different numbers of transmission layers, different transmission modes and different coherent configurations indicated by the power boosting configuration 2 in Table 4-1 may also be applied separately. For example, the terminal device may determine a power boosting value of a PTRS port when the values of {M,N} are {1,1} only based on Table 4-1, and determine power boosting values of the PTRS port corresponding to other values of {M,N} in a manner different from Table 4-1.

Optionally, if each panel can only support at most two transmission layers, that is, M and N are not greater than 2, power boosting values of the first PTRS port and the second PTRS port may be determined according to Table 4-2.

TABLE 4-2

| | {M, N} | | | | |
|---|---|---|---|---|---|
| | {1, 1} | {1, 2} | | {2, 2} | |
| | Config- | Config- | Config- | Config- | Config- |
| Coherent | uration | uration | uration | uration | uration |
| Configuration | 1-3 | 1 | 2-3 | 1 | 2-3 |
| Power boosting | {0, 0} | {0, 3} | {0, 0} | {3, 3} | {0, 0} |
| configuration 1 | | | | | |
| Power boosting | {0, 0} | {0, 3} | {0, 3} | {3, 3} | {3, 3} |
| configuration 2 | | | | | |

Table 4-2 may be part of the content of Table 4-1. It should be noted that the mapping relationship indicated by the power boosting configuration 1 and the mapping relationship indicated by the power boosting configuration 2 shown in the above Table 4-2 may be applied separately. In addition, the power boosting values corresponding to different numbers of transmission layers, different transmission modes and different coherent configurations indicated by the power boosting configuration 1 in Table 4-2 may be applied separately, and the power boosting values corresponding to different numbers of transmission layers, different transmission modes and different coherent configurations indicated by the power boosting configuration 2 in Table 4-2 may also be applied separately.

It should be noted that the terminal device may determine, according to the second configuration information transmitted by the network device, to use the power boosting configuration 1 or the power boosting configuration 2 shown in Table 4-1 (or Table 4-2) to determine the power boosting values of the first PTRS port and the second PTRS port.

Optionally, in the second scenario, that is, in the case where resources occupied by the plurality of PTRS ports are unavailable for transmission of the PUSCH, the terminal device may determine power boosting values of the first PTRS port and the second PTRS port according to the mapping relationship shown in Table 5-1 below.

TABLE 5-1

| Trans- | | | | | | | | | |
|---|---|---|---|---|---|---|---|---|---|
| mission | | | | | | | | | |
| mode and | {M, N} | | | | | | | | |
| coherent | {1, 1} | {1, 2} | | {2, 2} | | {2, 3} | | {3, 3} | |
| configur- | Configur- | Configur- | Configur- | Configur- | Configur- | Configur- | Configur- | Configur- | Configur- |
| ation | ation 1-4 | ation 1 | ation 2-4 | ation 1 | ation 2-4 | ation 1 | ation 2-4 | ation 1 | ation 2-4 |
| Power | {3, 3} | {3, 6} | {3, 3} | {6, 6} | {3, 3} | {6, 7.77} | {3, 3} | {7.77, 7.77} | {3, 3} |
| boosting | | | | | | | | | |
| configur- | | | | | | | | | |
| ation 1 | | | | | | | | | |
| Power | {3, 3} | {3, 6} | {3, 6} | {6, 6} | {6, 6} | {6, 7.77} | {6, 7.77} | {7.77, 7.77} | {7.77, 7.77} |
| boosting | | | | | | | | | |
| configur- | | | | | | | | | |
| ation 2 | | | | | | | | | |

| Trans- | | | | | | |
|---|---|---|---|---|---|---|
| mission | | | | | | |
| mode and | {M, N} | | | | | |
| coherent | {3, 4} | | | {4, 4} | | |
| configur- | Configur- | Configur- | Configur- | Configur- | Configur- | Configur- |
| ation | ation 1 | ation 2 | ation 3-4 | ation 1 | ation- 2 | ation 3-4 |
| Power | {7.77, 9} | {3, 6} | {3, 3} | {9, 9} | {6, 6} | {3, 3} |
| boosting | | | | | | |
| configur- | | | | | | |
| ation 1 | | | | | | |
| Power | {7.77, 9} | {7.77, 9} | {7.77, 9} | {9, 9} | {9, 9} | {9, 9} |
| boosting | | | | | | |
| configur- | | | | | | |
| ation 2 | | | | | | |

It should be noted that, in the embodiments of the present disclosure, presenting the above-mentioned mapping relationships in the manner of Table 5-1 is only for the sake of simplicity of description, rather than to limit that power boosting values corresponding to different numbers of transmission layers, different transmission modes and different coherent configurations are all determined according to the mapping relationships shown in Table 5-1. That is to say, the mapping relationship indicated by the power boosting configuration 1 and the mapping relationship indicated by the power boosting configuration 2 shown in the above Table 5-1 may be applied separately. In addition, the power boosting values corresponding to different numbers of transmission layers, different transmission modes and different coherent configurations indicated by the power boosting configuration 1 in Table 5-1 may be applied separately, and the power boosting values corresponding to different numbers of transmission layers, different transmission modes and different coherent configurations indicated by the power boosting configuration 2 in Table 5-1 may also be applied separately. For example, the terminal device may determine a power boosting value of a PTRS port when the values of {M,N} are {1,1} only based on Table 5-1, and determine power boosting values of the PTRS port corresponding to other values of {M,N} in a manner different from Table 5-1.

Optionally, if each panel can only support at most two transmission layers, that is, M and N are not greater than 2, power boosting values of the first PTRS port and the second PTRS port may be determined according to Table 5-2.

TABLE 5-2

| | {M, N} | | | | |
|---|---|---|---|---|---|
| | {1, 1} | {1, 2} | | {2, 2} | |
| Transmission mode | Config- | Config- | Config- | Config- | Config- |
| and coherent | uration | uration | uration | uration | uration |
| configuration | 1-3 | 1 | 2-3 | 1 | 2-3 |
| Power boosting | {3, 3} | {3, 6} | {3, 3} | {6, 6} | {3, 3} |
| configuration 1 | | | | | |
| Power boosting | {3, 3} | {3, 6} | {3, 6} | {6, 6} | {6, 6} |
| configuration 2 | | | | | |

Table 5-2 may be part of the content of Table 5-1. It should be noted that the mapping relationship indicated by the power boosting configuration 1 and the mapping relationship indicated by the power boosting configuration 2 shown in the above Table 5-2 may be applied separately. In addition, the power boosting values corresponding to different numbers of transmission layers, different transmission modes and different coherent configurations indicated by the power boosting configuration 1 in Table 5-2 may be applied separately, and the power boosting values corresponding to different numbers of transmission layers, different transmission modes and different coherent configurations indicated by the power boosting configuration 2 in Table 5-2 may also be applied separately.

It should be noted that the terminal device may determine, according to the second configuration information transmitted by the network device, to use the power boosting configuration 1 or the power boosting configuration 2 shown in Table 5-1 (or Table 5-2) to determine the power boosting values of the first PTRS port and the second PTRS port.

In yet another possible implementation, if the terminal device only supports performing PUSCH transmission on multiple panels by using a MIMO transmission mode of non-codebook based transmission, the terminal device may determine the power boosting value of each PTRS port based only on values of M and N, through a relationship corresponding to configuration 4 in Table 2-1 or Table 3-1.

Optionally, in the embodiments of the present disclosure, before determining the power boosting value of each PTRS port according to step 320, the terminal device may further receive first configuration information transmitted by the network device. The first configuration information is used to configure whether a resource occupied by a target PTRS port is available for transmission of transmission layers other than the target transmission layer in the plurality of transmission layers.

On this basis, the terminal device may determine, based on the first configuration information, whether to use the first mapping relationship/third mapping relationship shown in Table 2-1 corresponding to the first scenario, or the second mapping relationship/fourth mapping relationship shown in Table 3-1 corresponding to the second scenario, to determine the power boosting value of each PTRS port.

Embodiment 2: the target transmission layer(s) are transmission layer(s) corresponding to each PTRS port.

It should be understood that in the embodiments of the present disclosure, one or more transmission layers associated with one indication information may correspond to one PTRS port. The terminal device determines a power boosting value of each of a plurality of PTRS ports according to the number of transmission layer(s) corresponding to the PTRS port. That is to say, the power boosting value of any one of the plurality of PTRS ports may be determined according to the number of transmission layer(s) corresponding to the port. The terminal device may determine a power boosting value of each PTRS port in turn, and power boosting values corresponding to different PTRS ports may be different.

In a possible implementation, in the case where the target transmission layer(s) are transmission layer(s) corresponding to the PTRS port, the terminal device may determine the power boosting value of each PTRS port according to a mapping relationship shown in Table 6-1 below.

Optionally, in the case where the terminal device is in a first scenario, the terminal device may determine the power boosting value of each PTRS port according to the mapping relationship shown in Table 6-1. The first scenario may be that resources occupied by a target PTRS port are available for transmission of transmission layer(s) other than transmission layer(s) corresponding to the target PTRS port in the plurality of transmission layers. The target PTRS port herein is any one of the plurality of PTRS ports.

That is to say, in the case where the resources occupied by any PTRS port are available for transmission of transmission layer(s) other than the transmission layer(s) corresponding to the PTRS port, the terminal device may determine the power boosting value of each PTRS port based on the mapping relationship shown in Table 6-1.

In the first scenario, in order to ensure that signal transmit powers on different OFDMs are the same, power boost may be performed for a PTRS port on each panel based on the number of transmission layer(s) on the panel, without considering signal transmission on another panel.

TABLE 6-1

| Transmission | L | | | | | | | |
|---|---|---|---|---|---|---|---|---|
| mode and | 1 | 2 | | 3 | | 4 | | |
| coherent | Configur- | Configur- | Configur- | Configur- | Configur- | Configur- | Configur- | Configur- |
| configuration | ation 1-4 | ation 1 | ation 2-4 | ation 1 | ation 2-4 | ation 1 | ation 2 | ation 3-4 |
| Power boosting | 0 | 3 | 0 | 4.77 | 0 | 6 | 3 | 0 |
| configuration 1 | | | | | | | | |
| Power boosting | 0 | 3 | 3 | 4.77 | 4.77 | 6 | 6 | 6 |
| configuration 2 | | | | | | | | |

L is the number of transmission layer(s) corresponding to a PTRS port. Table 6-1 only shows the mapping relationship between different transmission modes and coherent configurations and power boosting values in the case where the number of PTRS ports is in a range from 1 to 4. In addition, the transmission mode and coherent configuration in Table 6-1 may include configuration 1 to configuration 4, which are the same as those described in embodiment 1 and will not be repeated here.

Optionally, in the first scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a fifth mapping relationship (i.e., the mapping relationship indicated by the power boosting configuration 1 shown in Table 6-1).

As can be seen from Table 6-1 that the fifth mapping relationship may include at least one of the following:
in the case where the number L of transmission layer(s) corresponding to a target PTRS port is 1 (that is, L=1), the target PTRS port has a power boosting value of 0 dB;
in the case where the number L of transmission layer(s) corresponding to a target PTRS port is 2 (that is, L=2): if the transmission mode and coherent configuration of the terminal device is the configuration 1, the target PTRS port has a power boosting value of 3 dB; if the transmission mode and coherent configuration of the terminal device is any one of the configuration 2 to the configuration 4, the target PTRS port has a power boosting value of 0 dB.

By analogy, in the case where the number L of transmission layer(s) corresponding to a target PTRS port is 4 (that is, L=4): if the transmission mode and coherent configuration of the terminal device is the configuration 1, the target PTRS port has a power boosting value of 6 dB; if the transmission mode and coherent configuration of the terminal device is the configuration 2, the target PTRS port has a power boosting value of 3 dB; if the transmission mode and coherent configuration of the terminal device is the configuration 3 or the configuration 4, the target PTRS port has a power boosting value of 0 dB.

Optionally, in the above first scenario, if the second configuration information transmitted by the network device instructs the terminal device to use manner 2 (i.e., determining the power boosting value of each PTRS port based only on the number of the target transmission layer(s)) to determine the power boosting value, the terminal device may determine the power boosting value of each PTRS port based on a seventh mapping relationship (i.e., the mapping relationship indicated by the power boosting configuration 2 shown in Table 6-1).

As can be seen from Table 6-1 that the seventh mapping relationship may include at least one of: in the case where the number L of transmission layer(s) corresponding to a PTRS port is 1 (that is, L=1), the target PTRS port having a power boosting value of 0 dB; in the case where the number L of transmission layer(s) corresponding to a target PTRS port is 2 (that is, L=2), the target PTRS port having a power boosting value of 3 dB; in the case where the number L of transmission layer(s) corresponding to a target PTRS port is 3 (that is, L=3), the target PTRS port having a power boosting value of 4.77 dB; in the case where the number L of transmission layer(s) corresponding to a target PTRS port is 4 (that is, L=4), the target PTRS port having a power boosting value of 6 dB. In these cases, the magnitude of the power boosting value is not related to the MIMO transmission mode and the codebook coherent configuration.

It should be noted that, for the power boosting configuration 1 and the power boosting configuration 2, the power boosting value corresponding to the configuration 1 may also be log 2(L).

It should also be noted that, in the embodiments of the present disclosure, presenting the above-mentioned mapping relationships in the manner of Table 6-1 is only for the sake of simplicity of description, rather than to limit that power boosting values corresponding to different numbers of transmission layers, different transmission modes and different coherent configurations are all determined according to the mapping relationships shown in Table 6-1. That is to say, the mapping relationship indicated by the power boosting configuration 1 and the mapping relationship indicated by the power boosting configuration 2 shown in the above Table 6-1 may be applied separately. In addition, the power boosting values corresponding to different numbers of transmission layers, different transmission modes and different coherent configurations indicated by the power boosting configuration 1 in Table 6-1 may be applied separately, and the power boosting values corresponding to different numbers of transmission layers, different transmission modes and different coherent configurations indicated by the power boosting configuration 2 in Table 6-1 may also be applied separately. For example, the terminal device may determine a power boosting value of a PTRS port when the values of {M,N} are {1,1} only based on Table 6-1, and determine power boosting values of the PTRS port corresponding to other values of {M,N} in a manner different from Table 6-1.

Optionally, in the first scenario, if each panel may only support at most two transmission layers, that is, L is not greater than 2, Table 6-2 may be used to determine a power boosting value of a PTRS port corresponding to each panel.

TABLE 6-2

| | L | | |
|---|---|---|---|
| Transmission mode | 1 | 2 | |
| and coherent | Configuration | Configuration | Configuration |
| configuration | 1-4 | 1 | 2-4 |
| Power boosting | 0 | 3 | 0 |
| configuration 1 | | | |
| Power boosting | 0 | 3 | 3 |
| configuration 2 | | | |

It should be noted that Table 6-2 may be part of the content of Table 6-1. It should be noted that the mapping relationship indicated by the power boosting configuration 1 and the mapping relationship indicated by the power boosting configuration 2 shown in the above Table 6-2 may be applied separately. In addition, the power boosting values corresponding to different numbers of transmission layers, different transmission modes and different coherent configurations indicated by the power boosting configuration 1 in Table 6-2 may be applied separately, and the power boosting values corresponding to different numbers of transmission layers, different transmission modes and different coherent configurations indicated by the power boosting configuration 2 in Table 6-2 may also be applied separately.

In addition, in the case where the target transmission layer(s) are transmission layer(s) corresponding to each PTRS port, the terminal device may also determine the power boosting value of each PTRS port according to a mapping relationship shown in Table 7-1.

Optionally, in the case where the terminal device is in the second scenario, the terminal device may determine the power boosting value of each PTRS port according to the mapping relationship shown in Table 7-1. The second scenario may be that resources occupied by the plurality of PTRS ports are unavailable for transmission of the PUSCH, that is, the data on one panel of the terminal device needs to be rate-matched with the PTRS signal on another panel.

On this basis, in the second scenario, in order to ensure that signal transmit power is the same on different OFDMs, in one aspect, it is necessary to perform power boost for the PTRS port on each panel according to the number of transmission layers on the panel. In another aspect, it is also necessary to consider the additional power required due to rate matching on PTRS resources of another panel, that is, it is necessary to add an additional 3 dB on the basis of Table 6-1, resulting in Table 7-1 as shown below. The terminal device may use the mapping relationship shown in the following Table 7-1 to determine the power boosting value of each PTRS port.

TABLE 7-1

| Transmission | L | | | | | | | |
|---|---|---|---|---|---|---|---|---|
| mode and | 1 | 2 | | 3 | | 4 | | |
| coherent | Configur- | Configur- | Configur- | Configur- | Configur- | Configur- | Configur- | Configur- |
| configuration | ation 1-4 | ation 1 | ration 2-4 | ration 1 | ration 2-4 | ation 1 | ation 2 | ation 3-4 |
| Power boosting | 3 | 6 | 3 | 7.77 | 3 | 9 | 6 | 3 |
| configuration 1 | | | | | | | | |
| Power boosting | 3 | 6 | 6 | 7.77 | 7.77 | 9 | 9 | 9 |
| configuration 2 | | | | | | | | |

Optionally, in the above second scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a sixth mapping relationship (i.e., the mapping relationship indicated by the power boosting configuration 1 shown in Table 7-1).

As can be seen from Table 7-1 that the sixth mapping relationship may include at least one of the following:
in the case where the number L of transmission layer(s) corresponding to a target PTRS port is 1 (that is, L=1), the target PTRS port has a power boosting value of 3 dB;
in the case where the number L of transmission layer(s) corresponding to a target PTRS port is 2 (that is, L=2): if the transmission mode and coherent configuration of the terminal device is the configuration 1, the target PTRS port has a power boosting value of 6 dB; if the transmission mode and coherent configuration of the terminal device is any one of the configuration 2 to the configuration 4, the target PTRS port has a power boosting value of 3 dB.

By analogy, in the case where the number L of transmission layer(s) corresponding to a target PTRS port is 4 (that is, L=4): if the transmission mode and coherent configuration of the terminal device is the configuration 1, the target PTRS port has a power boosting value of 9 dB; if the transmission mode and coherent configuration of the terminal device is the configuration 2, the target PTRS port has a power boosting value of 6 dB; if the transmission mode and coherent configuration of the terminal device is the configuration 3 or the configuration 4, the target PTRS port has a power boosting value of 3 dB.

Optionally, in the above second scenario, if the second configuration information transmitted by the network device instructs the terminal device to use manner 2 (i.e., determining the power boosting value of each PTRS port based only on the number of the target transmission layer(s)) to determine the power boosting value, the terminal device may determine the power boosting value of each PTRS port based on an eighth mapping relationship (i.e., the mapping relationship indicated by the power boosting configuration 2 shown in Table 7-1).

As can be seen from Table 7-1 that the eighth mapping relationship may include at lease one of following:
in the case where the number L of transmission layer(s) corresponding to a target PTRS port is 1 (that is, L=1), the target PTRS port having a power boosting value of 3 dB;
in the case where the number L of transmission layer(s) corresponding to a target PTRS port is 2 (that is, L=2), the target PTRS port having a power boosting value of 6 dB;
in the case where the number L of transmission layer(s) corresponding to a target PTRS port is 3 (that is, L=3), the target PTRS port having a power boosting value of 7.77 dB;
in the case where the number L of transmission layer(s) corresponding to a target PTRS port is 4 (that is, L=4), the target PTRS port having a power boosting value of 9 dB.

In these cases, the magnitude of the power boosting value is not related to the MIMO transmission mode and the codebook coherent configuration.

It should be noted that, in the embodiments of the present disclosure, presenting the above-mentioned mapping relationships in the manner of Table 7-1 is only for the sake of simplicity of description, rather than to limit that power boosting values corresponding to different numbers of transmission layers, different transmission modes and different coherent configurations are all determined according to the mapping relationships shown in Table 7-1. That is to say, the mapping relationship indicated by the power boosting configuration 1 and the mapping relationship indicated by the power boosting configuration 2 shown in the above Table 7-1 may be applied separately. In addition, the power boosting values corresponding to different numbers of transmission layers, different transmission modes and different coherent configurations indicated by the power boosting configuration 1 in Table 7-1 may be applied separately, and the power boosting values corresponding to different numbers of transmission layers, different transmission modes and different coherent configurations indicated by the power boosting configuration 2 in Table 7-1 may also be applied separately. For example, the terminal device may determine a power boosting value of a PTRS port when the values of {M,N} are {1,1} only based on Table 7-1, and determine power boosting values of the PTRS port corresponding to other values of {M,N} in a manner different from Table 7-1.

Optionally, in the second scenario, if each panel may only support at most two transmission layers, that is, L is not greater than 2, Table 7-2 may be used to determine a power boosting value of a PTRS port corresponding to each panel.

TABLE 7-2

| | L | | |
|---|---|---|---|
| Transmission mode | 1 | 2 | |
| and coherent | Configuration | Configuration | Configuration |
| configuration | 1-4 | 1 | 2-4 |
| Power boosting | 3 | 6 | 3 |
| configuration 1 | | | |
| Power boosting | 3 | 6 | 6 |
| configuration 2 | | | |

Table 7-2 may be part of the content of Table 7-1. It should be noted that the mapping relationship indicated by the power boosting configuration 1 and the mapping relationship indicated by the power boosting configuration 2 shown in the above Table 7-2 may be applied separately. In addition, the power boosting values corresponding to different numbers of transmission layers, different transmission modes and different coherent configurations indicated by the power boosting configuration 1 in Table 7-2 may be applied separately, and the power boosting values corresponding to different numbers of transmission layers, different transmission modes and different coherent configurations indicated by the power boosting configuration 2 in Table 7-2 may also be applied separately.

In another possible implementation, if the terminal device only supports performing PUSCH transmission on multiple panels by using a MIMO transmission mode of codebook based transmission, the terminal device may use a mapping relationship shown in Table 8-1 or Table 9-1 to determine the power boosting value of each PTRS port based on a value of the number L of transmission layer(s) corresponding to the PTRS port and the codebook coherent configuration. In this implementation, there may also be two scenarios for determining the power boosting value of each PTRS port.

Optionally, in the first scenario, that is, in the case where resources occupied by a target PTRS port are available for transmission of transmission layer(s) other than transmission layer(s) corresponding to the target PTRS port, the terminal device may determine the power boosting value of each PTRS port according to a mapping relationship shown in Table 8-1 below.

TABLE 8-1

| Transmission | L | | | | | | | |
|---|---|---|---|---|---|---|---|---|
| mode and | 1 | 2 | | 3 | | 4 | | |
| coherent | Configur- | Configur- | Configur- | Configur- | Configur- | Configur- | Configur- | Configur- |
| configuration | ation 1-3 | ation 1 | ation 2-3 | ation 1 | ation 2-3 | ation 1 | ation 2 | ation 3 |
| Power boosting | 0 | 3 | 0 | 4.77 | 0 | 6 | 3 | 0 |
| configuration 1 | | | | | | | | |
| Power boosting | 0 | 3 | 3 | 4.77 | 4.77 | 6 | 6 | 6 |
| configuration 2 | | | | | | | | |

It should be noted that, in the embodiments of the present disclosure, presenting the above-mentioned mapping relationships in the manner of Table 8-1 is only for the sake of simplicity of description, rather than to limit that power boosting values corresponding to different numbers of transmission layers, different transmission modes and different coherent configurations are all determined according to the mapping relationships shown in Table 8-1. That is to say, the mapping relationship indicated by the power boosting configuration 1 and the mapping relationship indicated by the power boosting configuration 2 shown in the above Table 8-1 may be applied separately. In addition, the power boosting values corresponding to different numbers of transmission layers, different transmission modes and different coherent configurations indicated by the power boosting configuration 1 in Table 8-1 may be applied separately, and the power boosting values corresponding to different numbers of transmission layers, different transmission modes and different coherent configurations indicated by the power boosting configuration 2 in Table 8-1 may also be applied separately. For example, the terminal device may determine a power boosting value of a PTRS port when the values of {M,N} are {1,1} only based on Table 8-1, and determine power boosting values of the PTRS port corresponding to other values of {M,N} in a manner different from Table 8-1.

Optionally, if each panel can only support at most two transmission layers, that is, Lis not greater than 2, the power boosting value of each PTRS port may be determined in turn according to Table 8-2.

TABLE 8-2

| | L | | |
|---|---|---|---|
| Transmission mode | 1 | 2 | |
| and coherent | Configuration | Configuration | Configuration |
| configuration | 1-3 | 1 | 2-3 |
| Power boosting | 0 | 3 | 0 |
| configuration 1 | | | |
| Power boosting | 0 | 3 | 3 |
| configuration 2 | | | |

It should be noted that Table 8-2 may be part of the content of Table 8-1. It should be noted that the mapping relationship indicated by the power boosting configuration 1 and the mapping relationship indicated by the power boosting configuration 2 shown in Table 8-2 may be applied separately. In addition, the power boosting values corresponding to different numbers of transmission layers, different transmission modes and different coherent configurations indicated by the power boosting configuration 1 in Table 8-2 may be applied separately, and the power boosting values corresponding to different numbers of transmission layers, different transmission modes and different coherent configurations indicated by the power boosting configuration 2 in Table 8-2 may also be applied separately.

In addition, in the first scenario, the terminal device may determine, according to the second configuration information transmitted by the network device, to use the power boosting configuration 1 or the power boosting configuration 2 shown in Table 8-1 (or Table 8-2) to determine the power boosting value of each PTRS port.

Optionally, in the second scenario, that is, in the case where resources occupied by the plurality of PTRS ports are unavailable for transmission of the PUSCH, the terminal device may determine the power boosting value of each PTRS port according to the mapping relationship shown in Table 9-1 below.

TABLE 9-1

| Transmission | L | | | | | | | |
|---|---|---|---|---|---|---|---|---|
| mode and | 1 | 2 | | 3 | | 4 | | |
| coherent | Configur- | Configur- | Configur- | Configur- | Configur- | Configur- | Configur- | Configur- |
| configuration | ation 1-3 | ation 1 | ation 2-3 | ation 1 | ation 2-3 | ation 1 | ation 2 | ation 3 |
| Power boosting | 3 | 6 | 3 | 7.77 | 3 | 9 | 6 | 3 |
| configuration 1 | | | | | | | | |
| Power boosting | 3 | 6 | 6 | 7.77 | 7.77 | 9 | 9 | 9 |
| configuration 2 | | | | | | | | |

It should be noted that, in the embodiments of the present disclosure, presenting the above-mentioned mapping relationships in the manner of Table 9-1 is only for the sake of simplicity of description, rather than to limit that power boosting values corresponding to different numbers of transmission layers, different transmission modes and different coherent configurations are all determined according to the mapping relationships shown in Table 9-1. That is to say, the mapping relationship indicated by the power boosting configuration 1 and the mapping relationship indicated by the power boosting configuration 2 shown in the above Table 9-1 may be applied separately. In addition, the power boosting values corresponding to different numbers of transmission layers, different transmission modes and different coherent configurations indicated by the power boosting configuration 1 in Table 9-1 may be applied separately, and the power boosting values corresponding to different numbers of transmission layers, different transmission modes and different coherent configurations indicated by the power boosting configuration 2 in Table 9-1 may also be applied separately. For example, the terminal device may determine a power boosting value of a PTRS port when the values of {M,N} are {1,1} only based on Table 9-1, and determine power boosting values of the PTRS port corresponding to other values of {M,N} in a manner different from Table 9-1.

Optionally, if each panel can only support at most two transmission layers, that is, Lis not greater than 2, the power boosting value of each PTRS port may be determined in turn according to Table 9-2.

TABLE 9-2

| | L | | |
|---|---|---|---|
| Transmission mode | 1 | 2 | |
| and coherent | Configuration | Configuration | Configuration |
| configuration | 1-3 | 1 | 2-3 |
| Power boosting | 3 | 6 | 3 |
| configuration 1 | | | |
| Power boosting | 3 | 6 | 6 |
| configuration 2 | | | |

It should be noted that Table 9-2 may be part of the content of Table 9-1. It should be noted that the mapping relationship indicated by the power boosting configuration 1 and the mapping relationship indicated by the power boosting configuration 2 shown in Table 9-2 may be applied separately. In addition, the power boosting values corresponding to different numbers of transmission layers, different transmission modes and different coherent configurations indicated by the power boosting configuration 1 in Table 9-2 may be applied separately, and the power boosting values corresponding to different numbers of transmission layers, different transmission modes and different coherent configurations indicated by the power boosting configuration 2 in Table 9-2 may also be applied separately.

In addition, in the second scenario, the terminal device may determine, according to the second configuration information transmitted by the network device, to use the power boosting configuration 1 or the power boosting configuration 2 shown in Table 9-1 (or Table 9-2) to determine the power boosting value of each PTRS port in turn.

In yet another possible implementation, if the terminal device only supports performing PUSCH transmission on multiple panels by using a MIMO transmission mode of non-codebook based transmission, the terminal device may determine the power boosting value of each PTRS port based only on values of L, through a relationship corresponding to configuration 4 in Table 6-1 or Table 7-1.

Optionally, in the embodiments of the present disclosure, before determining the power boosting value of each PTRS port in step 320, the terminal device may further receive first configuration information transmitted by the network device. The first configuration information is used to configure whether a resource occupied by a target PTRS port is available for transmission of transmission layers other than the target transmission layer in the plurality of transmission layers.

On this basis, the terminal device may determine, according to the first configuration information, whether to use the fifth mapping relationship/seventh mapping relationship shown in Table 6-1 corresponding to the first scenario, or the sixth mapping relationship/eighth mapping relationship shown in Table 7-1 corresponding to the second scenario, to determine the power boosting value of each PTRS port.

Embodiment 3: the target transmission layer(s) are all transmission layers of the PUSCH.

It should be noted that, in this embodiment, in the case where the target transmission layer(s) are all transmission layers of the PUSCH, transmission layers of the PUSCH on different panels are the same. That is to say, the numbers of transmission layers associated with different indication information are the same, or the numbers of transmission layers corresponding to different PTRS ports are the same. In this embodiment, power boosting values of different PTRS ports are the same.

In a possible implementation, in the case where the target transmission layer(s) are all transmission layers of the PUSCH, the terminal device may determine the power boosting value of each PTRS port according to a mapping relationship shown in Table 10-1.

Optionally, in the case where the terminal device is in a first scenario, the terminal device may determine the power boosting value of each PTRS port according to the mapping relationship shown in Table 10-1. The first scenario may be that resources occupied by a target PTRS port are available for transmission of transmission layer(s) other than transmission layer(s) corresponding to the target PTRS port in plurality of transmission layers. The target PTRS port herein is any one of the plurality of PTRS ports.

TABLE 10-1

| Transmission | K | | | | | | | |
|---|---|---|---|---|---|---|---|---|
| mode and | 2 | 4 | | 6 | | 8 | | |
| coherent | Configur- | Configur- | Configur- | Configur- | Configur- | Configur- | Configur- | Configur- |
| configuration | ation 1-4 | ation 1 | ation 2-4 | ation 1 | ation 2-4 | ation 1 | ation 2 | ation 3-4 |
| Power boosting | 0 | 3 | 0 | 4.77 | 0 | 6 | 3 | 0 |
| configuration 1 | | | | | | | | |
| Power boosting | 0 | 3 | 3 | 4.77 | 4.77 | 6 | 6 | 6 |
| configuration 2 | | | | | | | | |

K is the number of all transmission layers of the PUSCH. Table 10-1 only shows the mapping relationship between different transmission modes and coherent configurations and power boosting values in the cases where the number of PTRS ports is 2, 4, 6, and 8. In addition, the transmission mode and coherent configuration in Table 10-1 may include configuration 1 to configuration 4, which are the same as those described in embodiment 1 and will not be repeated here.

It should be noted that, in this embodiment, the number of indication information is 2, or the number of PTRS ports may be 2.

Optionally, in the first scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a ninth mapping relationship (i.e., the mapping relationship indicated by the power boosting configuration 1 shown in Table 10-1).

As can be seen from Table 10-1 that the ninth mapping relationship may include at least one of the following:
in the case where K=2 (that is, each indication information/PTRS port is associated with one transmission layer), each PTRS port has a power boosting value of 0 dB;
in the case where K=4 (that is, each indication information/PTRS port is associated with two transmission layers): if the transmission mode and coherent configuration of the terminal device is the configuration 1, each PTRS port has a power boosting value of 3 dB; if the transmission mode and coherent configuration of the terminal device is any one of the configuration 2 to the configuration 4, each PTRS port has a power boosting value of 0 dB;
in the case where K=6 (that is, each indication information/PTRS port is associated with three transmission layers): if the transmission mode and coherent configuration of the terminal device is the configuration 1, each PTRS port has a power boosting value of 4.77 dB; if the transmission mode and coherent configuration of the terminal device is any one of the configuration 2 to the configuration 4, each PTRS port has a power boosting value of 0 dB;
in the case where K=8 (that is, each indication information/PTRS port is associated with four transmission layers): if the transmission mode and coherent configuration of the terminal device is the configuration 1, each PTRS port has a power boosting value of 6 dB; if the transmission mode and coherent configuration of the terminal device is the configuration 2, each PTRS port has a power boosting value of 3 dB; if the transmission mode and coherent configuration of the terminal device is the configuration 3 or the configuration 4, each PTRS port has a power boosting value of 0 dB.

Optionally, in the first scenario described above, if the second configuration information transmitted by the network device instructs the terminal device to use manner 2 (i.e., determining the power boosting value of each PTRS port based only on the number of the target transmission layer(s)) to determine the power boosting value, the terminal device may determine the power boosting value of each PTRS port based on a eleventh mapping relationship (i.e., the mapping relationship indicated by the power boosting configuration 2 shown in Table 10-1).

As can be seen from Table 10-1 that the eleventh mapping relationship may include at least one of the following:
in the case where K=2 (that is, each indication information/PTRS port is associated with one transmission layer), each PTRS port has a power boosting value of 0 dB; in the case where K=4 (that is, each indication information/PTRS port is associated with two transmission layers), each PTRS port has a power boosting value of 3 dB; in the case where K=6 (that is, each indication information/PTRS port is associated with three transmission layers), each PTRS port has a power boosting value of 4.77 dB; in the case where K=8 (that is, each indication information/PTRS port is associated with four transmission layers), each PTRS port has a power boosting value of 6 dB. In these cases, the magnitude of the power boosting value is not related to the MIMO transmission mode and the codebook coherent configuration.

It should be noted that, for the power boosting configuration 1 and the power boosting configuration 2, the power boosting value corresponding to the configuration 1 may also be log 2(K/2).

It should also be noted that, in the embodiments of the present disclosure, presenting the above-mentioned mapping relationships in the manner of Table 10-1 is only for the sake of simplicity of description, rather than to limit that power boosting values corresponding to different numbers of transmission layers, different transmission modes and different coherent configurations are all determined according to the mapping relationships shown in Table 10-1. That is to say, the mapping relationship indicated by the power boosting configuration 1 and the mapping relationship indicated by the power boosting configuration 2 shown in the above Table 10-1 may be applied separately. In addition, the power boosting values corresponding to different numbers of transmission layers, different transmission modes and different coherent configurations indicated by the power boosting configuration 1 in Table 10-1 may be applied separately, and the power boosting values corresponding to different numbers of transmission layers, different transmission modes and different coherent configurations indicated by the power boosting configuration 2 in Table 10-1 may also be applied separately. For example, the terminal device may determine a power boosting value of a PTRS port when the values of {M,N} are {1,1} only based on Table 10-1, and determine power boosting values of the PTRS port corresponding to other values of {M,N} in a manner different from Table 10-1.

Optionally, in the first scenario, if each panel can only support at most two transmission layers, that is, K is not greater than 4, Table 10-2 may be used to determine a power boosting value of a PTRS port corresponding to each panel.

TABLE 10-2

| | K | | |
|---|---|---|---|
| Transmission mode | 2 | 4 | |
| and coherent | Configuration | Configuration | Configuration |
| configuration | 1-4 | 1 | 2-4 |
| Power boosting | 0 | 3 | 0 |
| configuration 1 | | | |
| Power boosting | 0 | 3 | 3 |
| configuration 2 | | | |

It should be noted that Table 10-2 may be part of the content of Table 10-1. It should be noted that the mapping relationship indicated by the power boosting configuration 1 and the mapping relationship indicated by the power boosting configuration 2 shown in Table 10-2 may be applied separately. In addition, the power boosting values corresponding to different numbers of transmission layers, different transmission modes and different coherent configurations indicated by the power boosting configuration 1 in Table 10-2 may be applied separately, and the power boosting values corresponding to different numbers of transmission layers, different transmission modes and different coherent configurations indicated by the power boosting configuration 2 in Table 10-2 may also be applied separately.

In addition, in the case where the target transmission layer(s) are all transmission layers of the PUSCH, the terminal device may also determine the power boosting value of each PTRS port according to mapping relationships shown in Table 11-1.

Optionally, in the case where the terminal device is in the second scenario, the terminal device may determine the power boosting value of each PTRS port according to the mapping relationships shown in Table 11-1. The second scenario may be that resources occupied by the plurality of PTRS ports are unavailable for transmission of the PUSCH, that is, the data on one panel of the terminal device needs to be rate-matched with the PTRS signal on another panel.

In the second scenario, in order to ensure that the signal transmit power is the same on different OFDMs, in an aspect, it is necessary to perform power boost for the PTRS port on each panel according to the number of transmission layers on the panel. In another aspect, it is also necessary to consider the additional power required due to rate matching on PTRS resources of another panel, that is, it is necessary to add an additional 3 dB on the basis of Table 10-1, resulting in Table 11-1 as shown below. The terminal device may use the mapping relationships shown in the following Table 11-1 to determine the power boosting value of each PTRS port.

TABLE 11-1

| Transmission | K | | | | | | | |
|---|---|---|---|---|---|---|---|---|
| mode and | 2 | 4 | | 6 | | 8 | | |
| coherent | Configur- | Configur- | Configur- | Configur- | Configur- | Configur- | Configur- | Configur- |
| configuration | ation 1-4 | ation 1 | ation 2-4 | ation 1 | ation 2-4 | ation 1 | ation 2 | ation 3-4 |
| Power boosting | 3 | 6 | 3 | 7.77 | 3 | 9 | 6 | 3 |
| configuration 1 | | | | | | | | |
| Power boosting | 3 | 6 | 6 | 7.77 | 7.77 | 9 | 9 | 9 |
| configuration 2 | | | | | | | | |

Optionally, in the second scenario, if the second configuration information transmitted by the network device instructs the terminal device to use manner 1 (i.e., determining the power boosting value of each PTRS port based on the number of the target transmission layer(s), the MIMO transmission mode of the PUSCH and the codebook coherent configuration) to determine the power boosting value, the terminal device may determine the power boosting value of each PTRS port based on a tenth mapping relationship (i.e., the mapping relationship indicated by the power boosting configuration 1 shown in Table 11-1).

As can be seen from Table 11-1 that the tenth mapping relationship may include at least one of the following:
in the case where K=2 (that is, each indication information/PTRS port is associated with one transmission layer), each PTRS port has a power boosting value of 3 dB;
in the case where K=4 (that is, each indication information/PTRS port is associated with two transmission layers): if the transmission mode and coherent configuration of the terminal device is the configuration 1, each PTRS port has a power boosting value of 6 dB; if the transmission mode and coherent configuration of the terminal device is any one of the configuration 2 to the configuration 4, each PTRS port has a power boosting value of 3 dB;
in the case where K=6 (that is, each indication information/PTRS port is associated with three transmission layers): if the transmission mode and coherent configuration of the terminal device is the configuration 1, each PTRS port has a power boosting value of 7.77 dB; if the transmission mode and coherent configuration of the terminal device is any one of the configuration 2 to the configuration 4, each PTRS port has a power boosting value of 3 dB;
in the case where K=8 (that is, each indication information/PTRS port is associated with four transmission layers): if the transmission mode and coherent configuration of the terminal device is the configuration 1, each PTRS port has a power boosting value of 9 dB; if the transmission mode and coherent configuration of the terminal device is the configuration 2, each PTRS port has a power boosting value of 6 dB; if the transmission mode and coherent configuration of the terminal device is the configuration 3 or the configuration 4, each PTRS port has a power boosting value of 3 dB.

Optionally, in the second scenario, if the second configuration information transmitted by the network device instructs the terminal device to use manner 2 (i.e., determining the power boosting value of each PTRS port based only on the number of the target transmission layer(s)) to determine the power boosting value, the terminal device may determine the power boosting value of each PTRS port based on a twelfth mapping relationship (i.e., the mapping relationship indicated by the power boosting configuration 2 shown in Table 11-1).

As can be seen from Table 11-1 that the twelfth mapping relationship may include at least one of the following:
in the case where K=2 (that is, each indication information/PTRS port is associated with one transmission layer), each PTRS port has a power boosting value of 3 dB; in the case where K=4 (that is, each indication information/PTRS port is associated with two transmission layers), each PTRS port has a power boosting value of 6 dB; in the case where K=6 (that is, each indication information/PTRS port is associated with three transmission layers), each PTRS port has a power boosting value of 7.77 dB; in the case where K=8 (that is, each indication information/PTRS port is associated with four transmission layers), each PTRS port has a power boosting value of 9 dB. In these cases, the magnitude of the power boosting value is not related to the MIMO transmission mode and the codebook coherent configuration.

It should be noted that, in the embodiments of the present disclosure, presenting the above-mentioned mapping relationships in the manner of Table 11-1 is only for the sake of simplicity of description, rather than to limit that power boosting values corresponding to different numbers of transmission layers, different transmission modes and different coherent configurations are all determined according to the mapping relationships shown in Table 11-1. That is to say, the mapping relationship indicated by the power boosting configuration 1 and the mapping relationship indicated by the power boosting configuration 2 shown in the above Table 11-1 may be applied separately. In addition, the power boosting values corresponding to different numbers of transmission layers, different transmission modes and different coherent configurations indicated by the power boosting configuration 1 in Table 11-1 may be applied separately, and the power boosting values corresponding to different numbers of transmission layers, different transmission modes and different coherent configurations indicated by the power boosting configuration 2 in Table 11-1 may also be applied separately. For example, the terminal device may determine a power boosting value of a PTRS port when the values of {M,N} are {1,1} only based on Table 11-1, and determine power boosting values of the PTRS port corresponding to other values of {M,N} in a manner different from Table 11-1.

Optionally, in the second scenario, if each panel can only support at most two transmission layers, that is, K is not greater than 4, Table 11-2 may be used to determine a power boosting value of a PTRS port corresponding to each panel.

TABLE 11-2

| | K | | |
|---|---|---|---|
| Transmission mode | 2 | 4 | |
| and coherent | Configuration | Configuration | Configuration |
| configuration | 1-4 | 1 | 2-4 |
| Power boosting | 3 | 6 | 3 |
| configuration 1 | | | |
| Power boosting | 3 | 6 | 6 |
| configuration 2 | | | |

It should be noted that Table 11-2 may be part of the content of Table 11-1. It should be noted that the mapping relationship indicated by the power boosting configuration 1 and the mapping relationship indicated by the power boosting configuration 2 shown in Table 11-2 may be applied separately. In addition, the power boosting values corresponding to different numbers of transmission layers, different transmission modes and different coherent configurations indicated by the power boosting configuration 1 in Table 11-2 may be applied separately, and the power boosting values corresponding to different numbers of transmission layers, different transmission modes and different coherent configurations indicated by the power boosting configuration 2 in Table 11-2 may also be applied separately.

In another possible implementation, if the terminal device only supports performing PUSCH transmission on multiple panels by using a MIMO transmission mode of codebook based transmission, the terminal device may use a mapping relationship shown in Table 12-1 or Table 13-1 to determine the power boosting value of each PTRS port based on a value of the number K of all transmission layers of the PUSCH and the codebook coherent configuration. In this implementation, there may also be two scenarios for determining the power boosting value of each PTRS port.

Optionally, in the first scenario, that is, in the case where resources occupied by a target PTRS port are available for transmission of transmission layer(s) other than transmission layer(s) corresponding to the target PTRS port, the terminal device may determine the power boosting value of each PTRS port according to a mapping relationship shown in Table 12-1 below.

TABLE 12-1

| Transmission | K | | | | | | | |
|---|---|---|---|---|---|---|---|---|
| mode and | 2 | 4 | | 6 | | 8 | | |
| coherent | Configur- | Configur- | Configur- | Configur- | Configur- | Configur- | Configur- | Configur- |
| configuration | ation 1-3 | ation 1 | ation 2-3 | ation 1 | ation 2-3 | ation 1 | ation 2 | ation 3 |
| Power boosting | 0 | 3 | 0 | 4.77 | 0 | 6 | 3 | 0 |
| configuration 1 | | | | | | | | |
| Power boosting | 0 | 3 | 3 | 4.77 | 4.77 | 6 | 6 | 6 |
| configuration 2 | | | | | | | | |

It should be noted that, in the embodiments of the present disclosure, presenting the above-mentioned mapping relationships in the manner of Table 12-1 is only for the sake of simplicity of description, rather than to limit that power boosting values corresponding to different numbers of transmission layers, different transmission modes and different coherent configurations are all determined according to the mapping relationships shown in Table 12-1. That is to say, the mapping relationship indicated by the power boosting configuration 1 and the mapping relationship indicated by the power boosting configuration 2 shown in the above Table 12-1 may be applied separately. In addition, the power boosting values corresponding to different numbers of transmission layers, different transmission modes and different coherent configurations indicated by the power boosting configuration 1 in Table 12-1 may be applied separately, and the power boosting values corresponding to different numbers of transmission layers, different transmission modes and different coherent configurations indicated by the power boosting configuration 2 in Table 12-1 may also be applied separately. For example, the terminal device may determine a power boosting value of a PTRS port when the values of {M,N} are {1,1} only based on Table 12-1, and determine power boosting values of the PTRS port corresponding to other values of {M,N} in a manner different from Table 12-1.

Optionally, if each panel can only support at most two transmission layers, that is, K is not greater than 4, the power boosting value of each PTRS port may be determined in turn according to Table 12-2.

TABLE 12-2

| | K | | |
|---|---|---|---|
| Transmission mode | 2 | 4 | |
| and coherent | Configuration | Configuration | Configuration |
| configuration | 1-3 | 1 | 2-3 |
| Power boosting | 0 | 3 | 0 |
| configuration 1 | | | |
| Power boosting | 0 | 3 | 3 |
| configuration 2 | | | |

It should be noted that Table 12-2 may be part of the content of Table 12-1. It should be noted that the mapping relationship indicated by the power boosting configuration 1 and the mapping relationship indicated by the power boosting configuration 2 shown in Table 12-2 may be applied separately. In addition, the power boosting values corresponding to different numbers of transmission layers, different transmission modes and different coherent configurations indicated by the power boosting configuration 1 in Table 12-2 may be applied separately, and the power boosting values corresponding to different numbers of transmission layers, different transmission modes and different coherent configurations indicated by the power boosting configuration 2 in Table 12-2 may also be applied separately.

It should be noted that, in the first scenario, the terminal device may determine, according to the second configuration information transmitted by the network device, to use the power boosting configuration 1 or the power boosting configuration 2 shown in Table 12-1 (or Table 12-2) to determine the power boosting value of each PTRS port.

Optionally, in the second scenario, that is, in the case where resources occupied by the plurality of PTRS ports are unavailable for transmission of the PUSCH, the terminal device may determine the power boosting value of each PTRS port according to the mapping relationship shown in Table 13-1 below.

TABLE 13-1

| Transmission | K | | | | | | | |
|---|---|---|---|---|---|---|---|---|
| mode and | 2 | 4 | | 6 | | 8 | | |
| coherent | Configur- | Configur- | Configur- | Configur- | Configur- | Configur- | Configur- | Configur- |
| configuration | ation 1-3 | ation 1 | ation 2-3 | ation 1 | ation 2-3 | ation 1 | ation 2 | ation 3 |
| Power boosting | 3 | 6 | 3 | 7.77 | 3 | 9 | 6 | 3 |
| configuration 1 | | | | | | | | |
| Power boosting | 3 | 6 | 6 | 7.77 | 7.77 | 9 | 9 | 9 |
| configuration 2 | | | | | | | | |

It should be noted that, in the embodiments of the present disclosure, presenting the above-mentioned mapping relationships in the manner shown in Table 13-1 is only for the sake of simplicity of description, rather than to limit that power boosting values corresponding to different numbers of transmission layers, different transmission modes and different coherent configurations are all determined according to the mapping relationships shown in Table 13-1. That is to say, the mapping relationship indicated by the power boosting configuration 1 and the mapping relationship indicated by the power boosting configuration 2 shown in Table 13-1 may be applied separately. In addition, the power boosting values corresponding to different numbers of transmission layers, different transmission modes and different coherent configurations indicated by the power boosting configuration 1 in Table 13-1 may be applied separately, and the power boosting values corresponding to different numbers of transmission layers, different transmission modes and different coherent configurations indicated by the power boosting configuration 2 in Table 13-1 may also be applied separately. For example, the terminal device may determine a power boosting value of a PTRS port when the values of {M,N} are {1,1} only based on Table 13-1, and determine power boosting values of the PTRS port corresponding to other values of {M,N} in a manner different from Table 13-1.

Optionally, if each panel can only support at most two transmission layers, that is, K is not greater than 4, the power boosting value of each PTRS port may be determined in turn according to Table 13-2.

TABLE 13-2

| | K | | |
|---|---|---|---|
| Transmission mode | 2 | 4 | |
| and coherent | Configuration | Configuration | Configuration |
| configuration | 1-3 | 1 | 2-3 |
| Power boosting | 3 | 6 | 3 |
| configuration 1 | | | |
| Power boosting | 3 | 6 | 6 |
| configuration 2 | | | |

It should be noted that Table 13-2 may be part of the content of Table 13-1. It should be noted that the mapping relationship indicated by the power boosting configuration 1 and the mapping relationship indicated by the power boosting configuration 2 shown in Table 13-2 may be applied separately. In addition, the power boosting values corresponding to different numbers of transmission layers, different transmission modes and different coherent configurations indicated by the power boosting configuration 1 in Table 13-2 may be applied separately, and the power boosting values corresponding to different numbers of transmission layers, different transmission modes and different coherent configurations indicated by the power boosting configuration 2 in Table 13-2 may also be applied separately.

In yet another possible implementation, if the terminal device only supports performing PUSCH transmission on multiple panels by using a MIMO transmission mode of non-codebook based transmission, the terminal device may determine the power boosting value of each PTRS port based only on the value of L, through a relationship corresponding to configuration 4 in Table 10-1 or Table 11-1.

Optionally, in the embodiments of the present disclosure, before determining the power boosting value of each PTRS port in step 320, the terminal device may further receive first configuration information transmitted by the network device. The first configuration information is used to configure whether resources occupied by a target PTRS port are available for transmission of transmission layers other than the target transmission layer in the plurality of transmission layers.

On this basis, the terminal device may determine, according to the first configuration information, whether to use the ninth mapping relationship/eleventh mapping relationship shown in Table 10-1 corresponding to the first scenario, or the tenth mapping relationship/twelfth mapping relationship shown in Table 11-1 corresponding to the second scenario, to determine the power boosting value of each PTRS port.

To summarize, in the method for determining a transmit power provided in the embodiments of the present disclosure, the terminal device may determine, according to an association relationship between indication information (SRI information or TCI state information) and transmission layers of the PUSCH, power boosting values used by PTRS ports corresponding to different panels, which may not only improve the phase tracking performance of uplink multi-panel simultaneous transmission by a higher power, but also ensure the power balance between different OFDM symbols and different antennas/panels, thereby reducing the complexity of terminal hardware implementation.

The preferred implementations of the present disclosure have been described above in detail with reference to the accompanying drawings. However, the present disclosure is not limited to the specific details in the foregoing implementations. Various simple modifications may be made to the technical solutions of the present disclosure within the technical concept of the present disclosure. These simple variants all fall within the protection scope of the present disclosure. For example, the various specific technical features described in the foregoing specific implementations may be combined with each other in any suitable manner without conflict. In order to avoid unnecessary repetition, the various possible combinations will not be described in the present disclosure. For another example, the various implementations of the present disclosure may be arbitrarily combined, which should also be regarded as the contents disclosed in the present disclosure as long as they do not violate the concept of the present disclosure. For another example, under the premise of no conflict, the various embodiments and/or the technical features in the various embodiments described in the present disclosure may be arbitrarily combined with the prior art, and the technical solution obtained by combination should also fall within the protection scope of the present disclosure.

It should also be understood that in various method embodiments of the present disclosure, sequence numbers of the above processes do not mean the order of execution of the processes. The order of execution of each process should be determined by its functions and internal logic, and should not constitute any limitation on implementation of the embodiments of the present disclosure. Furthermore, in the embodiments of the present disclosure, terms such as “downlink”, “uplink” and “sidelink” are intended to indicate transmission directions of signals or data. The term “downlink” is intended to indicate that a transmission direction of signals or data is a first direction of sending signals or data from a station to UE in a cell, the term “uplink” is intended to indicate that a transmission direction of signals or data is a second direction of sending signals or data from UE in a cell to a station, and the term “sidelink” is intended to indicate that a transmission direction of signals or data is a third direction of sending signals or data from UE 1 to UE 2. For example, “downlink signal” indicates that a transmission direction of the signal is the first direction. In addition, in the embodiments of the present disclosure, the term “and/or” refers to an association relationship describing associated objects, which indicates that there may be three kinds of relationships. For example, “A and/or B” may indicate three cases that: A exists alone, both A and B exist, and B exists alone. The character “/” herein generally indicates that associated objects before and after the character “/” have an “or” relationship.

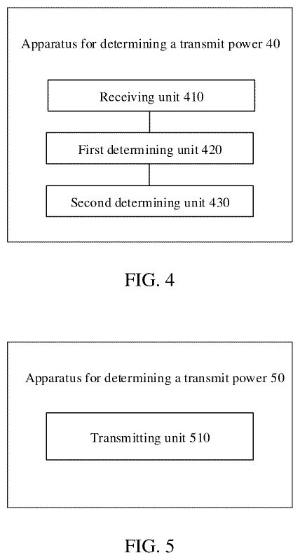

FIG. 4 is a first schematic diagram showing a structure of an apparatus for determining a transmit power provided by the embodiments of the present disclosure, which is applied to a terminal device. As shown in FIG. 4, the apparatus 40 for determining the transmit power includes:
a receiving unit 410 configured to receive a first message, where the first message includes a plurality of indication information associated with different transmission layers of a physical uplink shared channel (PUSCH), transmission layers associated with different indication information correspond to different PTRS ports, and the indication information is sounding reference signal resource indicator (SRI) information or transmission configuration indicator (TCI) state information;
a first determining unit 420 configured to determine a power boosting value of each PTRS port based on the number of target transmission layer(s), where the target transmission layer(s) are any one of: transmission layer(s) associated with a respective one of the plurality of indication information, transmission layer(s) corresponding to the PTRS port, and all transmission layers of the PUSCH; and
a second determining unit 430 configured to determine a transmit power of the PTRS port based on the power boosting value of the PTRS port.

Optionally, the first determining unit 420 is configured to determine the power boosting value of each PTRS port based on the number of the target transmission layer(s), a multiple-input multiple-output (MIMO) transmission mode of the PUSCH and a codebook coherent configuration.

Optionally, in the case where the target transmission layer(s) are the transmission layer(s) associated with a respective one of the plurality of indication information, the first determining unit 420 is specifically configured to determine the power boosting value of each PTRS port based on a first mapping relationship. The plurality of indication information includes first indication information and second indication information, the first indication information is associated with first transmission layer(s), and the second indication information is associated with second transmission layer(s). The first transmission layer(s) correspond to a first PTRS port, and the second transmission layer(s) correspond to a second PTRS port. The first mapping relationship includes at least one of the following:
in a case where M is 1 and N is 1, both the first PTRS port and the second PTRS port have a power boosting value of 0 dB, wherein M is a number of the first transmission layer(s), and N is a number of the second transmission layer(s);
in a case where M is 1 and N is 2, if the MIMO transmission mode is codebook based transmission and the codebook coherent configuration is full coherent configuration, the first PTRS port has a power boosting value of 0 dB, and the second PTRS port has a power boosting value of 3 dB;
in a case where M is 1 and N is 2, if the MIMO transmission mode is non-codebook based transmission, or the MIMO transmission mode is codebook based transmission and the codebook coherent configuration is non-full coherent configuration, both the first PTRS port and the second PTRS port have a power boosting value of 0 dB;
in a case where M is 2 and N is 2, if the MIMO transmission mode is codebook based transmission and the codebook coherent configuration is full coherent configuration, both the first PTRS port and the second PTRS port have a power boosting value of 3 dB;
in a case where M is 2 and N is 2, if the MIMO transmission mode is non-codebook based transmission, or the MIMO transmission mode is codebook based transmission and the codebook coherent configuration is non-full coherent configuration, both the first PTRS port and the second PTRS port have a power boosting value of 0 dB;
in a case where M is 2 and N is 3, if the MIMO transmission mode is codebook based transmission and the codebook coherent configuration is full coherent configuration, the first PTRS port has a power boosting value of 3 dB, and the second PTRS port has a power boosting value of 4.77 dB;
in a case where M is 2 and N is 3, if the MIMO transmission mode is non-codebook based transmission, or the MIMO transmission mode is codebook based transmission and the codebook coherent configuration is non-full coherent configuration, both the first PTRS port and the second PTRS port have a power boosting value of 0 dB;
in a case where M is 3 and N is 3, if the MIMO transmission mode is codebook based transmission and the codebook coherent configuration is full coherent configuration, both the first PTRS port and the second PTRS port have a power boosting value of 4.77 dB;
in a case where M is 3 and N is 3, if the MIMO transmission mode is non-codebook based transmission, or the MIMO transmission mode is codebook based transmission and the codebook coherent configuration is non-full coherent configuration, both the first PTRS port and the second PTRS port have a power boosting value of 0 dB;
in a case where M is 3 and N is 4, if the MIMO transmission mode is codebook based transmission and the codebook coherent configuration is full coherent configuration, the first PTRS port has a power boosting value of 4.77 dB, and the second PTRS port having a power boosting value of 6 dB;
in a case where M is 3 and N is 4, if the MIMO transmission mode is codebook based transmission and the codebook coherent configuration is partial coherent configuration, the first PTRS port has a power boosting value of 0 dB, and the second PTRS port has a power boosting value of 3 dB;
in a case where M is 3 and N is 4, if the MIMO transmission mode is non-codebook based transmission, or the MIMO transmission mode is codebook based transmission and the codebook coherent configuration is non-coherent configuration, both the first PTRS port and the second PTRS port have a power boosting value of 0 dB;
in a case where M is 4 and N is 4, if the MIMO transmission mode is codebook based transmission and the codebook coherent configuration is full coherent configuration, both the first PTRS port and the second PTRS port have a power boosting value of 6 dB;
in a case where M is 4 and N is 4, if the MIMO transmission mode is codebook based transmission and the codebook coherent configuration is partial coherent configuration, both the first PTRS port and the second PTRS port have a power boosting value of 3 dB; or
in a case where M is 4 and N is 4, if the MIMO transmission mode is non-codebook based transmission, or the MIMO transmission mode is codebook based transmission and the codebook coherent configuration is non-coherent configuration, both the first PTRS port and the second PTRS port have a power boosting value of 0 dB.

Optionally, in the case where the target transmission layer(s) are the transmission layer(s) associated with a respective one of the plurality of indication information, the first determining unit 420 is further configured to determine the power boosting value of each PTRS port based on a second mapping relationship. The second mapping relationship includes at least one of the following:
in a case where M is 1 and N is 1, both the first PTRS port and the second PTRS port have a power boosting value of 3 dB;
in a case where M is 1 and N is 2, if the MIMO transmission mode is codebook based transmission and the codebook coherent configuration is full coherent configuration, the first PTRS port has a power boosting value of 3 dB, and the second PTRS port has a power boosting value of 6 dB;
in a case where M is 1 and N is 2, if the MIMO transmission mode is non-codebook based transmission, or the MIMO transmission mode is codebook based transmission and the codebook coherent configuration is non-full coherent configuration, both the first PTRS port and the second PTRS port have a power boosting value of 3 dB;
in a case where M is 2 and N is 2, if the MIMO transmission mode is codebook based transmission and the codebook coherent configuration is full coherent configuration, both the first PTRS port and the second PTRS port have a power boosting value of 6 dB;
in a case where M is 2 and N is 2, if the MIMO transmission mode is non-codebook based transmission, or the MIMO transmission mode is codebook based transmission and the codebook coherent configuration is non-full coherent configuration, both the first PTRS port and the second PTRS port have a power boosting value of 3 dB;
in a case where M is 2 and N is 3, if the MIMO transmission mode is codebook based transmission and the codebook coherent configuration is full coherent configuration, the first PTRS port has a power boosting value of 6 dB, and the second PTRS port has a power boosting value of 7.77 dB;
in a case where M is 2 and N is 3, if the MIMO transmission mode is non-codebook based transmission, or the MIMO transmission mode is codebook based transmission and the codebook coherent configuration is non-full coherent configuration, both the first PTRS port and the second PTRS port have a power boosting value of 3 dB;
in a case where M is 3 and N is 3, if the MIMO transmission mode is codebook based transmission and the codebook coherent configuration is full coherent configuration, both the first PTRS port and the second PTRS port have a power boosting value of 7.77 dB;
in a case where M is 3 and N is 3, if the MIMO transmission mode is non-codebook based transmission, or the MIMO transmission mode is codebook based transmission and the codebook coherent configuration is non-full coherent configuration, both the first PTRS port and the second PTRS port have a power boosting value of 3 dB;
in a case where M is 3 and N is 4, if the MIMO transmission mode is codebook based transmission and the codebook coherent configuration is full coherent configuration, the first PTRS port has a power boosting value of 7.77 dB, and the second PTRS port has a power boosting value of 9 dB;
in a case where M is 3 and N is 4, if the MIMO transmission mode is codebook based transmission and the codebook coherent configuration is partial coherent configuration, the first PTRS port has a power boosting value of 3 dB, and the second PTRS port has a power boosting value of 6 dB;
in a case where M is 3 and N is 4, if the MIMO transmission mode is non-codebook based transmission, or the MIMO transmission mode is codebook based transmission and the codebook coherent configuration is non-coherent configuration, both the first PTRS port and the second PTRS port have a power boosting value of 3 dB;
in a case where M is 4 and N is 4, if the MIMO transmission mode is codebook based transmission and the codebook coherent configuration is full coherent configuration, both the first PTRS port and the second PTRS port have a power boosting value of 9 dB;
in a case where M is 4 and N is 4, if the MIMO transmission mode is codebook based transmission and the codebook coherent configuration is partial coherent configuration, both the first PTRS port and the second PTRS port have a power boosting value of 6 dB; or
in a case where M is 4 and N is 4, if the MIMO transmission mode is non-codebook based transmission, or the MIMO transmission mode is codebook based transmission and the codebook coherent configuration is non-coherent configuration, both the first PTRS port and the second PTRS port have a power boosting value of 3 dB.

Optionally, in the case where the target transmission layer(s) are the transmission layer(s) associated with a respective one of the plurality of indication information, the first determining unit 420 is specifically configured to determine the power boosting value of each PTRS port based on a third mapping relationship. The third mapping relationship includes at least one of the following:
in the case where M is 1 and N is 1, both the first PTRS port and the second PTRS port have a power boosting value of 0 dB;
in the case where M is 1 and N is 2, the first PTRS port has a power boosting value of 0 dB, and the second PTRS port has a power boosting value of 3 dB;
in the case where M is 2 and N is 2, both the first PTRS port and the second PTRS port have a power boosting value of 3 dB;
in the case where M is 2 and N is 3, the first PTRS port has a power boosting value of 3 dB, and the second PTRS port has a power boosting value of 4.77 dB;
in the case where M is 3 and N is 3, both the first PTRS port and the second PTRS port have a power boosting value of 4.77 dB;
in the case where M is 3 and N is 4, the first PTRS port has a power boosting value of 4.77 dB, and the second PTRS port has a power boosting value of 6 dB; or
in the case where M is 4 and N is 4, both the first PTRS port and the second PTRS port have a power boosting value of 6 dB.

Optionally, in the case where the target transmission layer(s) are the transmission layer(s) associated with a respective one of the plurality of indication information, the first determining unit 420 is specifically configured to determine the power boosting value of each PTRS port based on a fourth mapping relationship. The fourth mapping relationship includes at least one of the following:
in the case where M is 1 and N is 1, both the first PTRS port and the second PTRS port have a power boosting value of 3 dB;
in the case where M is 1 and N is 2, the first PTRS port has a power boosting value of 3 dB, and the second PTRS port has a power boosting value of 6 dB;
in the case where M is 2 and N is 2, both the first PTRS port and the second PTRS port have a power boosting value of 6 dB;
in the case where M is 2 and N is 3, the first PTRS port has a power boosting value of 6 dB, and the second PTRS port has a power boosting value of 7.77 dB;
in the case where M is 3 and N is 3, both the first PTRS port and the second PTRS port have a power boosting value of 7.77 dB;
in the case where M is 3 and N is 4, the first PTRS port has a power boosting value of 7.77 dB, and the second PTRS port has a power boosting value of 9 dB; or
in the case where M is 4 and N is 4, both the first PTRS port and the second PTRS port have a power boosting value of 9 dB.

Optionally, in the case where the target transmission layer(s) are the transmission layer(s) corresponding to each PTRS port, the first determining unit 420 is specifically configured to determine the power boosting value of each PTRS port based on a fifth mapping relationship. The fifth mapping relationship includes at least one of the following:
in the case where the number of transmission layer(s) corresponding to the target PTRS port is 1, the target PTRS port has a power boosting value of 0 dB, where the target PTRS port is any one of the plurality of PTRS ports;
in the case where the number of transmission layer(s) corresponding to the target PTRS port is 2, if the MIMO transmission mode is codebook based transmission and the codebook coherent configuration is full coherent configuration, the target PTRS port has a power boosting value of 3 dB;
in the case where the number of transmission layer(s) corresponding to the target is 2, if the MIMO transmission mode is non-codebook based transmission, or the MIMO transmission mode is codebook based transmission and the codebook coherent configuration is non-full coherent configuration, the target PTRS port has a power boosting value of 0 dB;
in the case where the number of transmission layer(s) corresponding to the target PTRS port is 3, if the MIMO transmission mode is codebook based transmission and the codebook coherent configuration is full coherent configuration, the target PTRS port has a power boosting value of 4.77 dB;
in the case where the number of transmission layer(s) corresponding to the target PTRS port is 3, if the MIMO transmission mode is non-codebook based transmission, or the MIMO transmission mode is codebook based transmission and the codebook coherent configuration is non-full coherent configuration, the target PTRS port has a power boosting value of 0 dB;
in the case where the number of transmission layer(s) corresponding to the target PTRS port is 4, if the MIMO transmission mode is codebook based transmission and the codebook coherent configuration is full coherent configuration, the target PTRS port has a power boosting value of 6 dB;
in the case where the number of transmission layer(s) corresponding to the target PTRS port is 4, if the MIMO transmission mode is codebook based transmission and the codebook coherent configuration is partial coherent configuration, the target PTRS port has a power boosting value of 3 dB; or
in the case where the number of transmission layer(s) corresponding to the target PTRS port is 4, if the MIMO transmission mode is non-codebook based transmission, or the MIMO transmission mode is codebook based transmission and the codebook coherent configuration is non-coherent configuration, the target PTRS port has a power boosting value of 0 dB.

Optionally, in the case where the target transmission layer(s) are the transmission layer(s) corresponding to each PTRS port, the first determining unit 420 is specifically configured to determine the power boosting value of each PTRS port based on a sixth mapping relationship. The sixth mapping relationship includes at least one of the following:
in the case where the number of transmission layer(s) corresponding to the target PTRS port is 1, the target PTRS port has a power boosting value of 3 dB;
in the case where the number of transmission layer(s) corresponding to the target PTRS port is 2, if the MIMO transmission mode is codebook based transmission and the codebook coherent configuration is full coherent configuration, the target PTRS port has a power boosting value of 6 dB;
in the case where the number of transmission layer(s) corresponding to the target PTRS port is 2, if the MIMO transmission mode is non-codebook based transmission, or the MIMO transmission mode is codebook based transmission and the codebook coherent configuration is non-full coherent configuration, the target PTRS port has a power boosting value of 3 dB;
in the case where the number of transmission layer(s) corresponding to the target PTRS port is 3, if the MIMO transmission mode is codebook based transmission and the codebook coherent configuration is full coherent configuration, the target PTRS port has a power boosting value of 7.77 dB;
in the case where the number of transmission layer(s) corresponding to the target PTRS port is 3, if the MIMO transmission mode is non-codebook based transmission, or the MIMO transmission mode is codebook based transmission and the codebook coherent configuration is non-full coherent configuration, the target PTRS port has a power boosting value of 3 dB;
in the case where the number of transmission layer(s) corresponding to the target PTRS port is 4, if the MIMO transmission mode is codebook based transmission and the codebook coherent configuration is full coherent configuration, the target PTRS port has a power boosting value of 9 dB;
in the case where the number of transmission layer(s) corresponding to the target PTRS port is 4, if the MIMO transmission mode is codebook based transmission and the codebook coherent configuration is a partial coherent configuration, the target PTRS port has a power boosting value of 6 dB; or
in the case where the number of transmission layer(s) corresponding to the target PTRS port is 4, if the MIMO transmission mode is non-codebook based transmission, or the MIMO transmission mode is codebook based transmission and the codebook coherent configuration is non-coherent configuration, the target PTRS port has a power boosting value of 3 dB.

Optionally, in the case where the target transmission layer(s) are the transmission layer(s) corresponding to each PTRS port, the first determining unit 420 is specifically configured to determine the power boosting value of each PTRS port based on a seventh mapping relationship. The seventh mapping relationship includes at least one of the following:
in the case where the number of transmission layer(s) corresponding to the target PTRS port is 1, the target PTRS port has a power boosting value of 0 dB;
in the case where the number of transmission layer(s) corresponding to the target PTRS port is 2, the target PTRS port has a power boosting value of 3 dB;
in the case where the number of transmission layer(s) corresponding to the target PTRS port is 3, the target PTRS port has a power boosting value of 4.77 dB; or
in the case where the number of transmission layer(s) corresponding to the target PTRS port is 4, the target PTRS port has a power boosting value of 6 dB.

Optionally, in the case where the target transmission layer(s) are the transmission layer(s) corresponding to each PTRS port, the first determining unit 420 is specifically configured to determine the power boosting value of each PTRS port based on an eighth mapping relationship. The eighth mapping relationship includes at least one of the following:
in the case where the number of transmission layer(s) corresponding to the target PTRS port is 1, the target PTRS port has a power boosting value of 3 dB;
in the case where the number of transmission layer(s) corresponding to the target PTRS port is 2, the target PTRS port has a power boosting value of 6 dB;
in the case where the number of transmission layer(s) corresponding to the target PTRS port is 3, the target PTRS port has a power boosting value of 7.77 dB; or
in the case where the number of transmission layer(s) corresponding to the target PTRS port is 4, the target PTRS port has a power boosting value of 9 dB.

Optionally, in the case where the target transmission layer(s) are all transmission layers of the PUSCH, the first determining unit 420 is specifically configured to determine the power boosting value of each PTRS port based on a ninth mapping relationship. The ninth mapping relationship includes at least one of the following:
in the case where the number of all transmission layers of the PUSCH is 2, each PTRS port has a power boosting value of 0 dB;
in the case where the number of all transmission layers of the PUSCH is 4, if the MIMO transmission mode is codebook based transmission and the codebook coherent configuration is full coherent configuration, each PTRS port has a power boosting value of 3 dB;
in the case where the number of all transmission layers of the PUSCH is 4, if the MIMO transmission mode is non-codebook based transmission, or the MIMO transmission mode is codebook based transmission and the codebook coherent configuration is non-full coherent configuration, each PTRS port has a power boosting value of 0 dB;
in the case where the number of all transmission layers of the PUSCH is 6, if the MIMO transmission mode is codebook based transmission and the codebook coherent configuration is full coherent configuration, each PTRS port has a power boosting value of 4.77 dB;
in the case where the number of all transmission layers of the PUSCH is 6, if the MIMO transmission mode is non-codebook based transmission, or the MIMO transmission mode is codebook based transmission and the codebook coherent configuration is non-full coherent configuration, each PTRS port has a power boosting value of 0 dB;
in the case where the number of all transmission layers of the PUSCH is 8, if the MIMO transmission mode is codebook based transmission and the codebook coherent configuration is full coherent configuration, each PTRS port has a power boosting value of 6 dB;
in the case where the number of all transmission layers of the PUSCH is 8, if the MIMO transmission mode is codebook based transmission and the codebook coherent configuration is partial coherent configuration, each PTRS port has a power boosting value of 3 dB; or
in the case where the number of all transmission layers of the PUSCH is 8, if the MIMO transmission mode is non-codebook based transmission, or the MIMO transmission mode is codebook based transmission and the codebook coherent configuration is non-coherent configuration, each PTRS port has a power boosting value of 0 dB.

Optionally, in the case where the target transmission layer(s) are all transmission layers of the PUSCH, the first determining unit 420 is specifically configured to determine the power boosting value of each PTRS port based on a tenth mapping relationship. The tenth mapping relationship includes at least one of the following:
in the case where the number of all transmission layers of the PUSCH is 2, each PTRS port has a power boosting value of 3 dB;
in the case where the number of all transmission layers of the PUSCH is 4, if the MIMO transmission mode is codebook based transmission and the codebook coherent configuration is full coherent configuration, each PTRS port has a power boosting value of 6 dB;
in the case where the number of all transmission layers of the PUSCH is 4, if the MIMO transmission mode is non-codebook based transmission, or the MIMO transmission mode is codebook based transmission and the codebook coherent configuration is non-full coherent configuration, each PTRS port has a power boosting value of 3 dB;
in the case where the number of all transmission layers of the PUSCH is 6, if the MIMO transmission mode is codebook based transmission and the codebook coherent configuration is full coherent configuration, each PTRS port has a power boosting value of 7.77 dB;
in the case where the number of all transmission layers of the PUSCH is 6, if the MIMO transmission mode is non-codebook based transmission, or the MIMO transmission mode is codebook based transmission and the codebook coherent configuration is non-full coherent configuration, each PTRS port has a power boosting value of 3 dB;
in the case where the number of all transmission layers of the PUSCH is 8, if the MIMO transmission mode is codebook based transmission and the codebook coherent configuration is full coherent configuration, each PTRS port has a power boosting value of 9 dB;
in the case where the number of all transmission layers of the PUSCH is 8, if the MIMO transmission mode is codebook based transmission and the codebook coherent configuration is partial coherent configuration, each PTRS port has a power boosting value of 6 dB; or
in the case where the number of all transmission layers of the PUSCH is 8, if the MIMO transmission mode is non-codebook based transmission, or the MIMO transmission mode is codebook based transmission and the codebook coherent configuration is non-coherent configuration, each PTRS port has a power boosting value of 3 dB.

Optionally, in the case where the target transmission layer(s) are all transmission layers of the PUSCH, the first determining unit 420 is specifically configured to determine the power boosting value of each PTRS port based on an eleventh mapping relationship. The eleventh mapping relationship includes at least one of the following:
in the case where the number of all transmission layers of the PUSCH is 2, each PTRS port has a power boosting value of 0 dB;
in the case where the number of all transmission layers of the PUSCH is 4, each PTRS port has a power boosting value of 3 dB;
in the case where the number of all transmission layers of the PUSCH is 6, each PTRS port has a power boosting value of 4.77 dB; or
in the case where the number of all transmission layers of the PUSCH is 8, each PTRS port has a power boosting value of 6 dB.

Optionally, in the case where the target transmission layer(s) are all transmission layers of the PUSCH, the first determining unit 420 is specifically configured to determine the power boosting value of each PTRS port based on a twelfth mapping relationship. The twelfth mapping relationship includes at least one of the following:
in the case where the number of all transmission layers of the PUSCH is 2, each PTRS port has a power boosting value of 3 dB;
in the case where the number of all transmission layers of the PUSCH is 4, each PTRS port has a power boosting value of 6 dB;
in the case where the number of all transmission layers of the PUSCH is 6, each PTRS port has a power boosting value of 7.77 dB; or
in the case where the number of all transmission layers of the PUSCH is 8, each PTRS port has a power boosting value of 9 dB.

Optionally, in the case where resources occupied by a target PTRS port are available for transmission of transmission layers other than the transmission layer(s) corresponding to the target PTRS port in the plurality of transmission layers, the terminal device determines the power boosting value of each PTRS port based on the first mapping relationship, the third mapping relationship, the fifth mapping relationship, the seventh mapping relationship, the ninth mapping relationship, or the eleventh mapping relationship. The target PTRS port is any one of the plurality of PTRS ports.

Optionally, in the case where resources occupied by the plurality of PTRS ports are unavailable for transmission of the PUSCH, the terminal device determines the power boosting value of each PTRS port based on the second mapping relationship, the fourth mapping relationship, the sixth mapping relationship, the eighth mapping relationship, the tenth mapping relationship, or the twelfth mapping relationship.

Optionally, the receiving unit 410 is further configured to receive first configuration information transmitted by a network device. The first configuration information is used to configure whether a resource occupied by a target PTRS port is available for transmission of transmission layers other than the target transmission layer(s) in the plurality of transmission layers.

Optionally, the receiving unit 410 is further configured to receive second configuration information transmitted by a network device. The second configuration information is used to configure the terminal device to determine the power boosting value of each PTRS port based on the number of the target transmission layer(s), or configure the terminal device to determine the power boosting value of each PTRS port based on the number of the target transmission layer(s), the MIMO transmission mode and a codebook coherent configuration mode.

Optionally, the first message is used to indicate that the PUSCH is transmitted on the plurality of antenna panels of the terminal device, and the plurality of indication information and the plurality of antenna panels are in a one-to-one correspondence.

Optionally, the receiving unit 410 is further configured to receive third configuration information transmitted by a network device. The third configuration information is used to indicate the number of all transmission layers of the PUSCH.

The number of transmission layer(s) associated with each of the plurality of indication information is determined based on the number of the plurality of indication information and the number of all transmission layers of the PUSCH.

Optionally, the apparatus 40 for determining the transmit power further includes a transmitting unit configured to transmit capability information to a network device. The capability information is used to indicate at least one of:
whether the terminal device supports enhanced PTRS power boosting;
whether transmission layers associated with different indication information support sharing of a transmit power; or
whether the plurality of antenna panels of the terminal device support sharing of a transmit power.

Optionally, the power boosting value represents a power boosting value of a target PTRS port relative to a DMRS port associated with the target PTRS port.

FIG. 5 is a second schematic diagram showing a structure of an apparatus for determining a transmit power provided by the embodiments of the present disclosure, which is applied to a network device. As shown in FIG. 5, the apparatus 50 for determining the transmit power includes:
a transmitting unit 510 configured to transmit a first message to a terminal device, where the first message includes a plurality of indication information associated with different transmission layers of a physical uplink shared channel (PUSCH), transmission layers associated with different indication information correspond to different PTRS ports, and the indication information is sounding reference signal resource indicator (SRI) information or transmission configuration indicator (TCI) state information. The number of target transmission layer(s) is used to determine a power boosting value of each PTRS port of the terminal device. The target transmission layer(s) are any one of transmission layer(s) associated with a respective one of the plurality of indication information, transmission layer(s) corresponding to the PTRS port, and all transmission layers of the PUSCH.

Optionally, the first message is used to indicate that the PUSCH is transmitted on a plurality of antenna panels of the terminal device, and the plurality of indication information and the plurality of antenna panels are in a one-to-one correspondence.

Optionally, the transmitting unit 510 is further configured to transmit first configuration information to the terminal device. The first configuration message is used to configure whether a resource occupied by a target PTRS port is available for transmission of transmission layers other than the transmission layer(s) corresponding to a target PTRS in a plurality of transmission layers. The target PTRS port is any one of the plurality of PTRS ports.

Optionally, the apparatus 50 for determining the transmit power further includes a receiving unit configured to receive capability information transmitted by the terminal device. The capability information is used to indicate at least one of
whether the terminal device supports enhanced PTRS power boosting;
whether transmission layers associated with different indication information support sharing of a transmit power; or
whether a plurality of antenna panels of the terminal device support sharing of a transmit power.

Optionally, the transmitting unit 510 is further configured to transmit second configuration information to the terminal device based on the capability information. The second configuration information is used to configure the terminal device to determine the power boosting value of each PTRS port based on the number of target transmission layer(s), or configure the terminal device to determine the power boosting value of each PTRS port based on the number of target transmission layer(s), the MIMO transmission mode and a codebook coherent configuration mode.

Optionally, if the capability information indicates that the terminal device supports enhanced PTRS power boosting, or indicates that transmission layers associated with different indication information support sharing of a transmit power, or indicates that the plurality of antenna panels of the terminal device support sharing of a transmit power, the second configuration information is used to configure the terminal device to determine the power boosting value of each PTRS port based on the number of the target transmission layer(s), the MIMO transmission mode and the code coherent configuration mode.

Optionally, if the capability information indicates that the terminal device does not support enhanced PTRS power boosting, or indicates that transmission layers associated with the different indication information do not support sharing of a transmit power, or indicates that the plurality of antenna panels of the terminal device do not support sharing of a transmit power, the second configuration information is used to configure the terminal device to determine the power boosting value of each PTRS port based on the number of the target transmission layer(s).

Those skilled in the art should understand that the relevant descriptions about the above-mentioned apparatus for determining a transmit power in the embodiments of the present disclosure can be understood by referring to the relevant descriptions about the method for determining a transmit power in the embodiments of the present disclosure.

FIG. 6 is a schematic diagram showing a structure of a communication device provided by the embodiments of the present disclosure. The communication device may be a terminal device or a network device. The communication device 600 shown in FIG. 6 includes a processor 610, which may call and run a computer program from a memory to implement the methods in the embodiments of the present disclosure.

Optionally, as shown in FIG. 6, the communication device 600 further includes a memory 620. The processor 610 may call and run a computer program from the memory 620 to implement the methods in the embodiments of the present disclosure.

The memory 620 may be a separate device independent of the processor 610, or may be integrated in the processor 610.

Optionally, as shown in FIG. 6, the communication device 600 may further include a transceiver 630, and the processor 610 may control the transceiver 630 to communicate with another device. Specifically, the transceiver 630 may send information or data to another device or receive information or data sent by another device.

The transceiver 630 may include a transmitter and a receiver. The transceiver 630 may further include an antenna, and the antenna may be singular or plural in quantity.

Optionally, the communication device 600 may specifically be the network device in the embodiments of the present disclosure, and the communication device 600 may implement corresponding processes implemented by the network device in various methods in the embodiments of the present disclosure, which will not be repeated here for brevity.

Optionally, the communication device 600 may specifically be the mobile terminal/terminal device in the embodiments of the present disclosure, and the communication device 600 may implement corresponding processes implemented by the mobile terminal/terminal device in various methods in the embodiments of the present disclosure, which will not be repeated here for brevity.

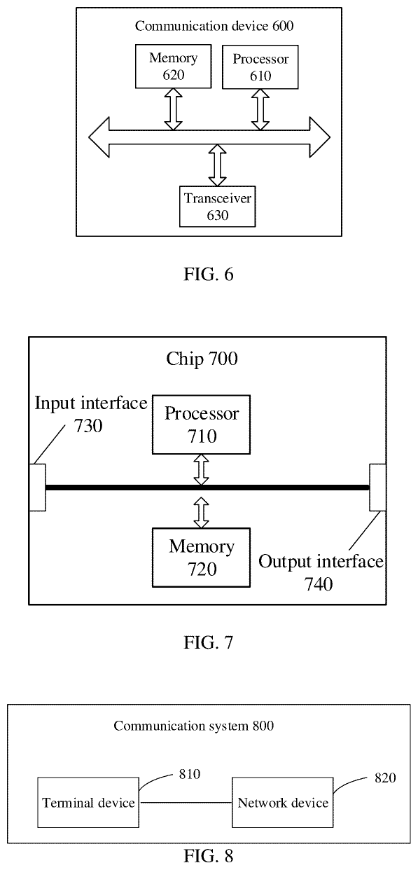

FIG. 7 is a schematic structural diagram of a chip according to embodiments of the present disclosure. The chip 700 shown in FIG. 7 includes a processor 710, which may call and run a computer program from a memory to implement the methods in the embodiments of the present disclosure.

Optionally, as shown in FIG. 7, the chip 700 may further include a memory 720. The processor 710 may invoke and execute a computer program stored from the memory 720 to implement the methods in the embodiments of the present disclosure.

The memory 720 may be a separate device independent of the processor 710, or may be integrated in the processor 710.

Optionally, the chip 700 may further include an input interface 730. The processor 710 may control the input interface 730 to communicate with another device or chip, specifically, to obtain information or data sent by another device or chip.

Optionally, the chip 700 may further include an output interface 740. The processor 710 may control the output interface 740 to communicate with another device or chip, specifically, to output information or data to another device or chip.

Optionally, the chip may be applied to the network device in the embodiments of the present disclosure, and the chip may implement corresponding processes implemented by the network device in various methods in the embodiments of the present disclosure, which will not be repeated here for brevity.

Optionally, the chip may be applied to the mobile terminal/terminal device in the embodiments of the present disclosure, and the chip may implement corresponding processes implemented by the mobile terminal/terminal device in various methods in the embodiments of the present disclosure, which will not be repeated here for brevity.

It should be understood that the chip mentioned in the embodiments of the present disclosure may also be called a system-level chip, a system chip, a chip system, or a system on chip.

FIG. 8 is a schematic block diagram of a communication system 800 provided by the embodiments of the present disclosure. As shown in FIG. 8, the communication system 800 includes a terminal device 810 and a network device 820.

The terminal device 810 may be configured to implement the corresponding functions implemented by the terminal device in the above-mentioned methods, and the network device 820 may be configured to implement the corresponding functions implemented by the network device in the above-mentioned methods, which will not be repeated herein for brevity.

It should be understood that the processor in the embodiments of the present disclosure may be an integrated circuit chip with a capability for processing signals. In an implementation process, various steps of the method embodiments described above may be completed through an integrated logic circuit of hardware in a processor or instructions in a form of software. The processor described above may be a general purpose processor, a digital signal processor (DSP), an application specific integrated circuit (ASIC), a field programmable gate array (FPGA), or another programmable logic device, a discrete gate or transistor logic device, or a discrete hardware component. The processor may implement various methods, steps, and logic block diagrams disclosed in the embodiments of the present disclosure. The general purpose processor may be a microprocessor or the processor may be any conventional processor. The steps of the methods disclosed in connection with the embodiments of the present disclosure may be directly embodied by execution of a hardware decoding processor, or by execution of a combination of hardware and software modules in a decoding processor. The software modules may be located in a storage medium commonly used in the art, such as a random access memory, a flash memory, a read-only memory, a programmable read-only memory or an electrically erasable programmable memory, or a register. The storage medium is located in a memory, and the processor reads information in the memory and completes the steps of the above methods in combination with hardware of the processor.

It will be appreciated that the memory in the embodiments of the present disclosure may be a volatile or non-volatile memory, or may include both volatile and non-volatile memories. The non-volatile memory may be a read-only memory (ROM), a programmable ROM (PROM), an erasable PROM (EPROM), electrically EPROM (EEPROM), or a flash memory. The volatile memory may be a random access memory (RAM) which serves as an external cache. As an example, but not as a limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct Rambus RAM (DR RAM). It should be noted that the memories of the systems and methods described herein are intended to include, but are not limited to, these and any other suitable types of memories.

It should be understood that the above memories are described as examples rather than limitations. For example, the memory in the embodiments of the present disclosure may be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (synch link DRAM, SLDRAM), or a direct Rambus RAM (DR RAM). That is to say, the memories in the embodiments of the present disclosure are intended to include, but are not limited to, these and any other suitable types of memories.

The embodiments of the present disclosure further provide a computer-readable storage medium configured to store a computer program.

Optionally, the computer-readable storage medium may be applied to the network device in the embodiments of the present disclosure, and the computer program causes a computer to perform corresponding processes implemented by the network device in various methods in the embodiments of the present disclosure, which will not be repeated here for brevity.

Optionally, the computer-readable storage medium may be applied to the mobile terminal/terminal device of the embodiments of the present disclosure, and the computer program causes a computer to perform corresponding processes implemented by the mobile terminal/terminal device in various methods in the embodiments of the present disclosure, which will not be repeated here for brevity.

The embodiments of the present disclosure further provide a computer program product including computer program instructions.

Optionally, the computer program product may be applied to the network device in the embodiments of the present disclosure, and the computer program instructions cause a computer to perform corresponding processes implemented by the network device in various methods in the embodiments of the present disclosure, which will not be repeated here for brevity.

Optionally, the computer program product may be applied to the mobile terminal/terminal device in the embodiments of the present disclosure, and the computer program instructions cause a computer to perform corresponding processes implemented by the mobile terminal/terminal device in various methods in the embodiments of the present disclosure, which will not be repeated here for brevity.

The embodiments of the present disclosure further provide a computer program.

Optionally, the computer program may be applied to the network device in the embodiments of the present disclosure. The computer program, when running on a computer, causes the computer to perform corresponding processes implemented by the network device in various methods in the embodiments of the present disclosure, which will not be repeated here for brevity.

Optionally, the computer program may be applied to the mobile terminal/terminal device in the embodiments of the present disclosure. The computer program, when running on a computer, causes the computer to perform corresponding processes implemented by the mobile terminal/terminal device in various methods in the embodiments of the present disclosure, which will not be repeated here for brevity.

Those of ordinary skills in the art will recognize that units and algorithm steps of various examples described in connection with the embodiments disclosed herein may be implemented in electronic hardware, or a combination of computer software and electronic hardware. Whether these functions are implemented in a form of hardware or software depends on a specific application and a design constraint of a technical solution. Those skilled in the art may use different methods to implement the described functions for each specific application, but such implementation should not be considered to be beyond the scope of the present disclosure.

Those skilled in the art may clearly understand that for convenience and conciseness of description, specific working processes of the systems, devices/apparatuses, and units described above may refer to corresponding processes in the aforementioned method embodiments, and details will not be repeated here.

In several embodiments according to the present disclosure, it should be understood that the disclosed systems, devices/apparatuses, and methods may be implemented in other ways. For example, the device/apparatus embodiments described above are only illustrative, for example, the division of the units is only a logical function division, and there may be other division manners in actual implementation. For example, multiple units or components may be combined or integrated into another system, or some features may be ignored or not executed. In addition, coupling or direct coupling or communication connection shown or discussed between each other, which may be indirect coupling or communication connection between the devices or units via some interfaces, may be electrical, mechanical, or in other forms.

The units described as separate components may be or may be not physically separated, and the component shown as a unit may be or may be not a physical unit, i.e., it may be located in one place or may be distributed on multiple network units. Some or all of units may be selected according to actual needs to achieve purposes of technical solutions of the embodiments.

In addition, various functional units in various embodiments of the present disclosure may be integrated in one processing unit, or various units may be physically present separately, or two or more units may be integrated in one unit.

The functions, if implemented in a form of software functional units and sold or used as an independent product, may be stored in a computer-readable storage medium. For such understanding, the technical solutions of the present disclosure, in essence, or the part which contributes to the prior art, or part of the technical solutions, may be embodied in the form of a software product, in which the computer software product is stored in one storage medium including a number of instructions for causing one computer device (which may be a personal computer, a server, or a network device) to perform all or some of the steps of the methods according to various embodiments of the present disclosure. The aforementioned storage media includes various media capable of storing program codes, such as a U disk, a mobile hard disk, a read-only memory (Read-Only Memory, ROM), a random access memory (Random Access Memory, RAM), a magnetic disk, an optical disk, and the like.

The foregoing are merely specific embodiments of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

What is claimed is:

1. A method for determining a transmit power, the method comprising:
receiving, by a terminal device, a first message, wherein the first message comprises a plurality of indication information associated with different transmission layers of a physical uplink shared channel (PUSCH), transmission layers associated with different indication information correspond to different phase tracking reference signal (PTRS) ports, and the indication information is sounding reference signal resource indicator (SRI) information or transmission configuration indicator (TCI) state information;
determining, by the terminal device, a power boosting value of each PTRS port based on a number of target transmission layer(s), wherein the target transmission layer(s) are any one of: transmission layer(s) associated with a respective one of the plurality of indication information, transmission layer(s) corresponding to the PTRS port, and all transmission layers of the PUSCH; and
determining, by the terminal device, a transmit power of the PTRS port based on the power boosting value of the PTRS port.

2. The method according to claim 1, wherein determining, by the terminal device, the power boosting value of each PTRS port based on the number of target transmission layer(s) comprises:
determining, by the terminal device, the power boosting value of each PTRS port based on the number of the target transmission layer(s), a multiple-input multiple-output (MIMO) transmission mode of the PUSCH and a codebook coherent configuration.

3. The method according to claim 2, wherein the target transmission layer(s) are the transmission layer(s) corresponding to the PTRS port; and
determining, by the terminal device, the power boosting value of each PTRS port based on the number of the target transmission layer(s), the multiple-input multiple-output (MIMO) transmission mode of the PUSCH, and the codebook coherent configuration comprises:
determining, by the terminal device, the power boosting value of each PTRS port based on a sixth mapping relationship, wherein the sixth mapping relationship comprises at least one of:
in a case where a number of transmission layer(s) corresponding to a target PTRS port is 1, the target PTRS port having a power boosting value of 3 dB; wherein the target PTRS port is any one of a plurality of PTRS ports indicated to the terminal device;
in a case where the number of transmission layer(s) corresponding to the target PTRS port is 2, if the MIMO transmission mode is codebook based transmission and the codebook coherent configuration is full coherent configuration, the target PTRS port having a power boosting value of 6 dB;
in a case where the number of transmission layer(s) corresponding to the target PTRS port is 2, if the MIMO transmission mode is non-codebook based transmission, or the MIMO transmission mode is codebook based transmission and the codebook coherent configuration is non-full coherent configuration, the target PTRS port having a power boosting value of 3 dB;
in a case where the number of transmission layer(s) corresponding to the target PTRS port is 3, if the MIMO transmission mode is codebook based transmission and the codebook coherent configuration is full coherent configuration, the target PTRS port having a power boosting value of 7.77 dB;
in a case where the number of transmission layer(s) corresponding to the target PTRS port is 3, if the MIMO transmission mode is non-codebook based transmission, or the MIMO transmission mode is codebook based transmission and the codebook coherent configuration is non-full coherent configuration, the target PTRS port having a power boosting value of 3 dB;
in a case where the number of transmission layer(s) corresponding to the target PTRS port is 4, if the MIMO transmission mode is codebook based transmission and the codebook coherent configuration is full coherent configuration, the target PTRS port having a power boosting value of 9 dB;
in a case where the number of transmission layer(s) corresponding to the target PTRS port is 4, if the MIMO transmission mode is codebook based transmission and the codebook coherent configuration is partial coherent configuration, the target PTRS port having a power boosting value of 6 dB; or
in a case where the number of transmission layer(s) corresponding to the target PTRS port is 4, if the MIMO transmission mode is non-codebook based transmission, or the MIMO transmission mode is codebook based transmission and the codebook coherent configuration is non-coherent configuration, the target PTRS port having a power boosting value of 3 dB.

4. The method according to claim 1, wherein the target transmission layer(s) are transmission layer(s) corresponding to a target PTRS port, the target PTRS port is any one of a plurality of PTRS ports indicated to the terminal device, and resources occupied by the plurality of PTRS ports are unavailable for transmission of the PUSCH;
determining the power boosting value of each PTRS port comprises:
determining a power boosting value of the target PTRS port based on a first power boosting configuration or a second power boosting configuration;
the first power boosting configuration comprises:
in a case where the number of transmission layer(s) corresponding to the target PTRS port is 1, the target PTRS port having a power boosting value of 3 dB;
in a case where the number of transmission layer(s) corresponding to the target PTRS port is 2, if a transmission mode and coherent configuration of the terminal device is a first configuration, the target PTRS port having a power boosting value of 6 dB;
in a case where the number of transmission layer(s) corresponding to the target PTRS port is 2, if the transmission mode and coherent configuration of the terminal device is any one of a second configuration, a third configuration and a fourth configuration, the target PTRS port having a power boosting value of 3 dB;
the second power boosting configuration comprises:
in a case where the number of transmission layer(s) corresponding to the target PTRS port is 1, the target PTRS port having a power boosting value of 3 dB;
in a case where the number of transmission layer(s) corresponding to the target PTRS port is 2, the target PTRS port having a power boosting value of 6 dB.

5. The method according to claim 4, wherein before determining the power boosting value of each PTRS port, the method further comprises:
determining, by the terminal device according to second configuration information, that the power boosting value of each PTRS port is to be determined based on the first power boosting configuration or the second power boosting configuration, wherein the second configuration information is carried in higher layer signaling.

6. The method according to claim 4, wherein the first configuration refers to that a MIMO transmission mode of the PUSCH is configured to be codebook based transmission and a codebook coherent configuration is configured to be full coherent configuration;
the second configuration refers to that the MIMO transmission mode of the PUSCH is configured to be the codebook based transmission and the codebook coherent configuration is configured to be partial coherent configuration;
the third configuration refers to that the MIMO transmission mode of the PUSCH is configured to be the codebook based transmission and the codebook coherent configuration is configured to be non-coherent configuration; and
the fourth configuration refers to that the MIMO transmission mode of the PUSCH is configured to be non-codebook based transmission.

7. The method according to claim 1, wherein before determining the power boosting value of each PTRS port, the method further comprises:
receiving, by the terminal device, second configuration information transmitted by a network device, wherein the second configuration information is used to configure the terminal device to determine the power boosting value of each PTRS port based on the number of the target transmission layer(s), or configure the terminal device to determine the power boosting value of each PTRS port based on the number of target transmission layer(s), a MIMO transmission mode and a codebook coherent configuration mode.

8. The method according to claim 7, wherein the second configuration information is carried in higher layer signaling.

9. The method according to claim 1, wherein the power boosting value represents a power boosting value of a target PTRS port relative to a demodulation reference signal (DMRS) port associated with a target PTRS port that is one of a plurality of PTRS ports indicated to the terminal device.

10. A method for determining a transmit power, the method comprising:
transmitting, by a network device, a first message to a terminal device, wherein the first message comprises a plurality of indication information associated with different transmission layers of a physical uplink shared channel (PUSCH), transmission layers associated with different indication information correspond to different PTRS ports, and the indication information is sounding reference signal resource indicator (SRI) information or transmission configuration indicator (TCI) state information; a number of target transmission layer(s) is used to determine a power boosting value of each PTRS port of the terminal device; and the target transmission layer(s) are any one of: transmission layer(s) associated with a respective one of the plurality of indication information, transmission layer(s) corresponding to the PTRS port, and all transmission layers of the PUSCH.

11. The method according to claim 10, further comprising:
receiving, by the network device, capability information transmitted by the terminal device, wherein the capability information is used to indicate at least one of:
whether the terminal device supports enhanced PTRS power boosting;
whether the transmission layers associated with the different indication information support sharing of a transmit power; or
whether a plurality of antenna panels of the terminal device support sharing of a transmit power.

12. The method according to claim 11, further comprising:
transmitting, by the network device, second configuration information to the terminal device based on the capability information, wherein the second configuration information is used to configure the terminal device to determine the power boosting value of each PTRS port based on the number of the target transmission layer(s), or configure the terminal device to determine the power boosting value of each PTRS port based on the number of the target transmission layer(s), a MIMO transmission mode and a code coherent configuration mode.

13. A terminal device, comprising a memory and a processor, wherein the memory is configured to store a computer program, and the processor is configured to call and run the computer program stored in the memory to cause the terminal device to perform:
receiving a first message, wherein the first message comprises a plurality of indication information associated with different transmission layers of a physical uplink shared channel (PUSCH), transmission layers associated with different indication information correspond to different phase tracking reference signal (PTRS) ports, and the indication information is sounding reference signal resource indicator (SRI) information or transmission configuration indicator (TCI) state information;
determining a power boosting value of each PTRS port based on a number of target transmission layer(s), wherein the target transmission layer(s) are any one of: transmission layer(s) associated with a respective one of the plurality of indication information, transmission layer(s) corresponding to the PTRS port, and all transmission layers of the PUSCH; and
determining a transmit power of the PTRS port based on the power boosting value of the PTRS port.

14. The terminal device according to claim 13, wherein determining the power boosting value of each PTRS port based on the number of target transmission layer(s) comprises:
determining the power boosting value of each PTRS port based on the number of the target transmission layer(s), a multiple-input multiple-output (MIMO) transmission mode of the PUSCH and a codebook coherent configuration.

15. The terminal device according to claim 14, wherein the target transmission layer(s) are the transmission layer(s) corresponding to the PTRS port; and
determining the power boosting value of each PTRS port based on the number of the target transmission layer(s), the multiple-input multiple-output (MIMO) transmission mode of the PUSCH, and the codebook coherent configuration comprises:
determining the power boosting value of each PTRS port based on a sixth mapping relationship, wherein the sixth mapping relationship comprises at least one of:
in a case where a number of transmission layer(s) corresponding to a target PTRS port is 1, the target PTRS port having a power boosting value of 3 dB; wherein the target PTRS port is any one of a plurality of PTRS ports indicated to the terminal device;
in a case where the number of transmission layer(s) corresponding to the target PTRS port is 2, if the MIMO transmission mode is codebook based transmission and the codebook coherent configuration is full coherent configuration, the target PTRS port having a power boosting value of 6 dB;
in a case where the number of transmission layer(s) corresponding to the target PTRS port is 2, if the MIMO transmission mode is non-codebook based transmission, or the MIMO transmission mode is codebook based transmission and the codebook coherent configuration is non-full coherent configuration, the target PTRS port having a power boosting value of 3 dB;
in a case where the number of transmission layer(s) corresponding to the target PTRS port is 3, if the MIMO transmission mode is codebook based transmission and the codebook coherent configuration is full coherent configuration, the target PTRS port having a power boosting value of 7.77 dB;
in a case where the number of transmission layer(s) corresponding to the target PTRS port is 3, if the MIMO transmission mode is non-codebook based transmission, or the MIMO transmission mode is codebook based transmission and the codebook coherent configuration is non-full coherent configuration, the target PTRS port having a power boosting value of 3 dB;
in a case where the number of transmission layer(s) corresponding to the target PTRS port is 4, if the MIMO transmission mode is codebook based transmission and the codebook coherent configuration is full coherent configuration, the target PTRS port having a power boosting value of 9 dB;
in a case where the number of transmission layer(s) corresponding to the target PTRS port is 4, if the MIMO transmission mode is codebook based transmission and the codebook coherent configuration is partial coherent configuration, the target PTRS port having a power boosting value of 6 dB; or
in a case where the number of transmission layer(s) corresponding to the target PTRS port is 4, if the MIMO transmission mode is non-codebook based transmission, or the MIMO transmission mode is codebook based transmission and the codebook coherent configuration is non-coherent configuration, the target PTRS port having a power boosting value of 3 dB.

16. The terminal device according to claim 13, wherein the target transmission layer(s) are transmission layer(s) corresponding to a target PTRS port, the target PTRS port is any one of a plurality of PTRS ports indicated to the terminal device, and resources occupied by the plurality of PTRS ports are unavailable for transmission of the PUSCH;
determining the power boosting value of each PTRS port comprises:
determining a power boosting value of the target PTRS port based on a first power boosting configuration or a second power boosting configuration;
the first power boosting configuration comprises:
in a case where the number of transmission layer(s) corresponding to the target PTRS port is 1, the target PTRS port having a power boosting value of 3 dB;
in a case where the number of transmission layer(s) corresponding to the target PTRS port is 2, if a transmission mode and coherent configuration of the terminal device is a first configuration, the target PTRS port having a power boosting value of 6 dB;
in a case where the number of transmission layer(s) corresponding to the target PTRS port is 2, if the transmission mode and coherent configuration of the terminal device is any one of a second configuration, a third configuration and a fourth configuration, the target PTRS port having a power boosting value of 3 dB;
the second power boosting configuration comprises:
in a case where the number of transmission layer(s) corresponding to the target PTRS port is 1, the target PTRS port having a power boosting value of 3 dB;
in a case where the number of transmission layer(s) corresponding to the target PTRS port is 2, the target PTRS port having a power boosting value of 6 dB.

17. The terminal device according to claim 16, wherein before determining the power boosting value of each PTRS port, the terminal device further performs:
determining, according to second configuration information, that the power boosting value of each PTRS port is to be determined based on the first power boosting configuration or the second power boosting configuration, wherein the second configuration information is carried in higher layer signaling.

18. The terminal device according to claim 16, wherein the first configuration refers to that a MIMO transmission mode of the PUSCH is configured to be codebook based transmission and a codebook coherent configuration is configured to be full coherent configuration;
the second configuration refers to that the MIMO transmission mode of the PUSCH is configured to be the codebook based transmission and the codebook coherent configuration is configured to be partial coherent configuration;
the third configuration refers to that the MIMO transmission mode of the PUSCH is configured to be the codebook based transmission and the codebook coherent configuration is configured to be non-coherent configuration; and
the fourth configuration refers to that the MIMO transmission mode of the PUSCH is configured to be non-codebook based transmission.

19. The terminal device according to claim 13, wherein before determining the power boosting value of each PTRS port, the terminal device further performs:
receiving second configuration information transmitted by a network device, wherein the second configuration information is used to configure the terminal device to determine the power boosting value of each PTRS port based on the number of the target transmission layer(s), or configure the terminal device to determine the power boosting value of each PTRS port based on the number of target transmission layer(s), a MIMO transmission mode and a codebook coherent configuration mode.

20. The terminal device according to claim 13, wherein the power boosting value represents a power boosting value of a target PTRS port relative to a demodulation reference signal (DMRS) port associated with a target PTRS port that is one of a plurality of PTRS ports indicated to the terminal device.
